(19) United States
(12) Patent Application Publication
(10) Pub. No.: US 2018/0332607 A1
(43) Pub. Date: Nov. 15, 2018

(54) Methods in a Communication Devices for Facilitating Communication of Downlink Control Information

(71) Applicant: Telefonaktiebolaget LM Ericsson (publ), Stockholm (SE)

(72) Inventors: Pål Frenger, Linköping (SE); Erik Eriksson, Linköping (SE); Jonas Fröberg Olsson, Ljungsbro (SE); Martin Hessler, Linköping (SE)

(21) Appl. No.: 15/777,530

(22) PCT Filed: Dec. 4, 2015
(86) PCT No.: PCT/SE2015/051308

§ 371 Date: May 18, 2018

(51) Int. Cl. H04W 72/12; H04W 72/14

(52) U.S. Cl. CPC H04W 72/1289; H04W 72/14

(57) ABSTRACT

Method for facilitating communication of control information. A message (200) is defined to communicate control information. The message (200) comprises a sequence of bits (201). A first mapping (202) defines how to interpret the message (200), defining which bits comprise a value of a first set of values (203), and for which variable in a first set of control information variables (204). The first communication device communication device (101) obtains (301) an update on how to interpret the message (200). The update is based on a second mapping (401). The second mapping (401) defines which bits in the sequence comprise a value of the second set of values (402), and for which variable. The first communication device (101) initiates (302) sending of an indicator of said update to a second communication device (102). The message (200) is devoid of the indicator or an indication of any of the first and second mapping (401).

### TECHNICAL FIELD

The present disclosure relates generally to a first communication device and methods performed thereby for facilitating communication of control information to a second communication device. The present disclosure also relates generally to a second communication device and methods performed thereby for facilitating communication of control information from a first communication device.

### BACKGROUND

Communication devices such as terminals are also known as e.g. User Equipments (UEs), wireless devices, mobile terminals, wireless terminals and/or mobile stations. Wireless devices are enabled to communicate wirelessly in a cellular communications network or wireless communication system, sometimes also referred to as a cellular radio system or cellular networks. The communication may be performed e.g. between two wireless devices, between a wireless device and a regular telephone and/or between a wireless device and a server via a Radio Access Network (RAN) and possibly one or more core networks, comprised within the cellular communications network.

Wireless devices may further be referred to as mobile telephones, cellular telephones, laptops, or surf plates with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another wireless device or a server.

The cellular communications network covers a geographical area which is divided into cell areas, wherein each cell area being served by an access node such as a Base Station (BS), e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the wireless devices within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3^{rd} Generation Partnership Project (3GPP) Long Term Evolution (LTE), base stations, which may be referred to as Evolved Nodes B (eNodeBs) or even eNBs, may be directly connected to one or more core networks.

3GPP LTE radio access standard has been written in order to support high bitrates and low latency both for uplink and downlink traffic. All data transmission is in LTE controlled by the radio base station.

In wireless communication network, a communication device or node, e.g., a UE in a LTE network, receiving data, may only be able to decode the received data after knowing the format of the received data. The format in which the data may be communicated between network communication devices may be transmitted as control information in a specified and known way. The control information may be transmitted in a message comprising a sequence of bits. The receiving communication device may need to first decode the control information in the message before being able to decode the data. The format of the received, or transmitted, data may be referred to as the transport format. Examples of information comprised in the control information, which may be referred to as formatting information, may be: allocation, where the data is located, typically in frequency, number of layers used also referred to as Rank, modulation and coding information, demodulation reference symbols, etc. . . .

The format in which the data may be communicated may depend on the capabilities of the communication devices. Because a transmitting device may not be aware of the capabilities of the receiving device, after it may have sent data to it in a specific format, the format in which the data may be communicated at a certain time point in the communication between two communication devices may depend on the state in which the communication devices may be, that is on the phase of their communication.

In LTE networks, the control information may be transmitted on the Physical Downlink Control Channel (PDCCH) or the evolved Physical Downlink Control Channel (ePDCCH) using a variety of Downlink Control Information (DCI) formats which may be specific to different operating modes, that is capabilities or state, of the UE. DCI may be used to describe the control signaling messages transmitted on the PDCCH, including for example downlink resource assignments (for the Physical Downlink Shared CHannel (PDCCH)) and uplink transmission grants (for the Physical Uplink Shared CHannel (PUSCH)), as described in e.g., 3GPP TS36.212 V12.6.0, or Release 12, 3GPP TS36.212 V8.8.0, Release 8. For example, in the random access procedure, the eNB, when sending a random access response to a UE may use DCI format 1A. The eNB may use this format since this is known to all UEs and the eNB does not know the actual capabilities of the UE when sending the random access response. Later in the call setup procedure, the eNB may learn the UE capabilities and may start using a more advanced DCI format according to the UE capabilities. For example, in the call-setup procedure, the eNB may only communicate with UE with a certain DCI format, but later, the eNB may know that UE has capability of supporting Multiple-Input Multiple-Output (MIMO), and the eNB may then use a different DCI format used for MIMO transmissions.

As the telecommunication technology evolves, so do the capabilities of the communication devices. Therefore, there is an increasing need to create new formats to transmit data, to adapt to the emerging capabilities of the ever evolving communication devices. Consequently, there is also a need to adapt the control information. Supporting this many DCI formats requires tedious testing and implementation. Moreover, the designed formats may contain control information that may not be used by the communication devices, therefore creating unnecessary overhead.

LTE is an example of this situation. As LTE has evolved with new features, the number of DCI formats has increased significantly. In LTE release 12, there are 13 different DCI formats, including both UL and DL DCIs.

All DCI formats are dimensioned for the most complex case, given the features they support. That is, the DCI format may contains bits for all possible alternative ways to communicate although only a fraction of the alternatives may actually be used.

For example, Format 1A, which may be considered as a simple format, may support a large range of allocation sizes as well as the full range of Modulation and Coding Scheme (MCS) values. Thus, Format 1A may support both the possibility to send a flexible small number of data bits in a suitable robust format, small MCS, as well as bulk data with optimized MCS selection. When considering a typical traffic flow, e.g., slow start of a Transmission Control Protocol (TCP) connection, one may notice that in the beginning of a flow transmission there may typically not be much data. Furthermore, in Machine-Type Communication (MTC) there may often be little amount of data that may need to be communicated, and for such traffic the flexibility in the DCI formats may just be creating overhead. This may be solved by defining a new DCI format, but such an approach scales bad considering the wide range of services with significantly different requirements that 5G systems are targeting. That is, since 5G is targeting such a wide range of applications and services, defining a new DCI format for each application and service may lead to a very large number of different DCI format.

### SUMMARY

It is an object of embodiments herein to facilitate the communication of control information among communication devices in a wireless communications network.

According to a first aspect of embodiments herein, the object is achieved by a method performed by a first communication device. The method is for facilitating communication of control information to a second communication device. A message is defined as a type of message to communicate control information to the second communication device. The message comprises a sequence of bits. A first mapping defines how to interpret the message by defining which bits in the sequence of bits comprise a value of a first set of values, and for which variable in a first set of control information variables. The first communication device and the second communication device operate in a wireless communications network. The method first communication device obtains an update on how to interpret the message. The update is based on a second mapping to a second set of values for a second set of control information variables. The second mapping defines which bits in the sequence of bits comprise a value of the second set of values, and for which variable in the second set of control information variables. The first communication device initiates sending of an indicator of said update to the second communication device. The message is devoid of the indicator of the update or an indication of any of the first mapping and the second mapping.

According to a second aspect of embodiments herein, the object is achieved by a method performed by the second communication device. The method is for facilitating communication of control information from the first communication device. The message is defined as a type of message to communicate control information to the second communication device. The message comprises the sequence of bits. The first mapping defines how to interpret the message by defining which bits in the sequence of bits comprise a value of the first set of values, and for which variable in the first set of control information variables. The first communication device and the second communication device operate in the wireless communications network. The second communication device receives, from the first communication device, the indicator of the update on how to interpret the message. The update is based on the second mapping to the second set of values for the second set of control information variables. The second mapping defines which bits in the sequence of bits comprise a value of the second set of values, and for which variable in the second set of control information variables. The message is devoid of the indicator of the update or an indication of any of the first mapping and the second mapping.

According to a third aspect of embodiments herein, the object is achieved by the first communication device configured to facilitate communication of control information to the second communication device. The message is defined as the type of message to communicate control information to the second communication device. The message comprises the sequence of bits. The first mapping defines how to interpret the message by defining which bits in the sequence of bits comprise a value of the first set of values, and for which variable in the first set of control information variables. The first communication device and the second communication device are configured to operate in the wireless communications network. The first communication device is further configured to obtain the update on how to interpret the message. The update is based on the second mapping to the second set of values for the second set of control information variables. The second mapping defines which bits in the sequence of bits comprise a value of the second set of values, and for which variable in the second set of control information variables. The first communication device is further configured to initiate sending of the indicator of said update to the second communication device. The message is devoid of the indicator of the update or the indication of any of the first mapping and the second mapping.

According to a fourth aspect of embodiments herein, the object is achieved by the second communication device configured to facilitate communication of control information from the first communication device. The message is defined as the type of message to communicate control information to the second communication device. The message comprises the sequence of bits. The first mapping defines how to interpret the message by defining which bits in the sequence of bits comprise a value of the first set of values, and for which variable in the first set of control information variables. The first communication device and the second communication device are configured to operate in the wireless communications network. The second communication device is further configured to receive, from the first communication device, the indicator of the update on how to interpret the message. The update is based on the second mapping to the second set of values for the second set of control information variables. The second mapping defines which bits in the sequence of bits comprise a value of the second set of values, and for which variable in the second set of control information variables. The message is devoid of the indicator of the update or the indication of any of the first mapping and the second mapping.

According to a fifth aspect of embodiments herein, the object is achieved by the first communication device to facilitate communication of control information to the second communication device. The message is defined as the type of message to communicate control information to the second communication device. The message comprises the sequence of bits. The first mapping defines how to interpret the message by defining which bits in the sequence of bits comprise a value of the first set of values, and for which variable in the first set of control information variables. The first communication device and the second communication device are configured to operate in the wireless communications network. The first communication device comprises an obtaining module configured to obtain the update on how to interpret the message. The update is based on the second mapping to the second set of values for the second set of control information variables. The second mapping defines which bits in the sequence of bits comprise a value of the second set of values, and for which variable in the second set of control information variables. The first communication device further comprises an initiating module configured to initiate sending of the indicator of said update to the second communication device. The message is devoid of the indicator of the update or the indication of any of the first mapping and the second mapping.

According to a sixth aspect of embodiments herein, the object is achieved by a second communication device to facilitate communication of control information from the first communication device. The message is defined as the type of message to communicate control information to the second communication device. The message comprises a sequence of bits. The first mapping defines how to interpret the message by defining which bits in the sequence of bits comprise a value of the first set of values, and for which variable in the first set of control information variables. The first communication device and the second communication device are configured to operate in the wireless communications network. The second communication device comprises a receiving module configured to receive, from the first communication device, the indicator of the update on how to interpret the message. The update is based on the second mapping to the second set of values for the second set of control information variables. The second mapping defines which bits in the sequence of bits comprise a value of the second set of values, and for which variable in the second set of control information variables. The message is devoid of the indicator of the update or the indication of any of the first mapping and the second mapping.

According to a seventh aspect of embodiments herein, the object is achieved by the first communication device operative to facilitate communication of control information to the second communication device. The message is defined as the type of message to communicate control information to the second communication device. The message comprises the sequence of bits. The first mapping defines how to interpret the message by defining which bits in the sequence of bits comprise a value of the first set of values, and for which variable in the first set of control information variables. The first communication device and the second communication device are operative in the wireless communications network. The first communication device comprises a processor and a memory. Said memory contains instructions executable by said processor, whereby said first communication device 101 is operative to obtain the update on how to interpret the message. The update is based on the second mapping to the second set of values for the second set of control information variables. The second mapping defines which bits in the sequence of bits comprise a value of the second set of values, and for which variable in the second set of control information variables. Said first communication device 101 is further operative to initiate sending of the indicator of said update to the second communication device. The message is devoid of the indicator of the update or the indication of any of the first mapping and the second mapping.

According to an eighth aspect of embodiments herein, the object is achieved by the second communication device operative to facilitate communication of control information from the first communication device. The message is defined as the type of message to communicate control information to the second communication device. The message comprises the sequence of bits. The first mapping defines how to interpret the message by defining which bits in the sequence of bits comprise a value of the first set of values, and for which variable in the first set of control information variables. The first communication device and the second communication device are operative in the wireless communications network. The second communication device comprises a processor and a memory. Said memory contains instructions executable by said processor, whereby said second communication device is operative to receive, from the first communication device, the indicator of the update on how to interpret the message. The update is based on the second mapping to the second set of values for the second set of control information variables. The second mapping defines which bits in the sequence of bits comprise a value of the second set of values, and for which variable in the second set of control information variables. The message is devoid of the indicator of the update or the indication of any of the first mapping and the second mapping.

By the first communication device obtaining the update on how to interpret the message, and initiating sending of the indicator of the update to the second communication device, the first communication device may provide control information to the second communication device, which control information may be dynamically adjusted to the operating mode of the second communication device, without incurring in unnecessary overhead, and without requiring the need to create new formats for the control information. Thus, the provided method scales optimally to the foreseen increases in the number of applications and services supported by future communication devices, which will require corresponding changes in the transmitted control information.

In consequence, the overall capacity of the wireless communications network is increased, and the latency reduced, increasing the efficiency of the communications within the wireless communications network.

### BRIEF DESCRIPTION OF THE DRAWINGS

Examples of embodiments herein are described in more detail with reference to the accompanying drawings, in which:

FIG. 1 is a schematic diagram illustrating a wireless communications network, according to some embodiments.

FIG. 2 is a schematic diagram illustrating a message and first mapping, according to some embodiments.

FIG. 3 is a schematic flowchart illustrating a method in a first communication device, according to some embodiments.

FIG. 4 is a schematic diagram illustrating a second mapping, according to some embodiments.

FIG. 5 is a schematic flowchart illustrating a method in a second communication device, according to some embodiments.

FIG. 6 is a schematic diagram illustrating a method in a wireless communications network, according to some embodiments.

FIG. 7 is a schematic diagram illustrating a method in a wireless communications network, according to some embodiments.

FIG. 8a is a schematic diagram illustrating a method in a wireless communications network, according to some embodiments.

FIG. 8b is a schematic diagram illustrating a method in a wireless communications network, according to some embodiments.

FIG. 9 is a block diagram illustrating embodiments of a first communication device, according to some embodiments.

FIG. 10 is a block diagram illustrating embodiments of a second communication device, according to some embodiments.

### DETAILED DESCRIPTION

Embodiments will now be described more fully hereinafter with reference to the accompanying drawings, in which examples of the claimed subject matter are shown. The claimed subject matter may, however, be embodied in many different forms and should not be construed as limited to the embodiments set forth herein. Rather, these embodiments are provided so that this disclosure will be thorough and complete, and will fully convey the scope of the claimed subject matter to those skilled in the art. It should also be noted that these embodiments are not mutually exclusive. Components from one embodiment may be tacitly assumed to be present/used in another embodiment.

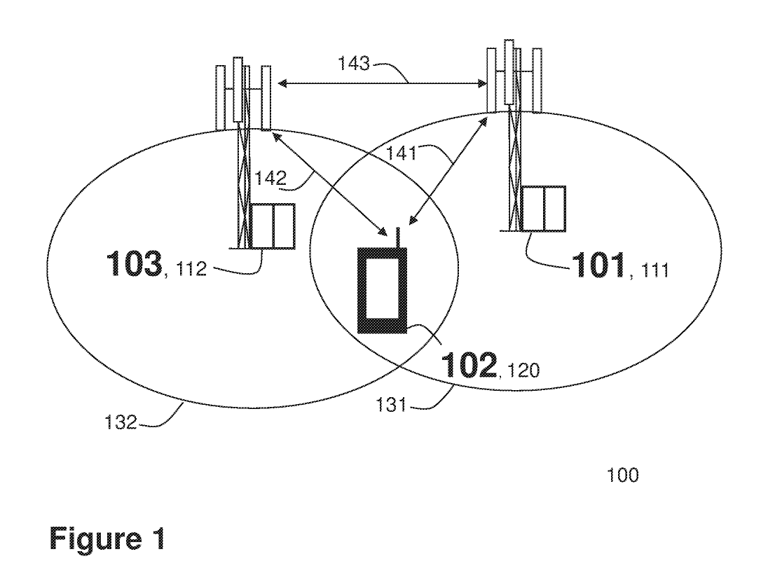

FIG. 1 depicts an example of a wireless communications network 100, sometimes also referred to as a cellular radio system, radio network or wireless communications system, in which embodiments herein may be implemented. The wireless communications network 100 may for example be a network such as Long-Term Evolution (LTE), e.g. LTE Frequency Division Duplex (FDD), LTE Time Division Duplex (TDD), LTE Half-Duplex Frequency Division Duplex (HD-FDD), LTE operating in an unlicensed band, or a Wideband Code Division Multiple Access (WCDMA), Universal Terrestrial Radio Access (UTRA) TDD, Ultra-Mobile Broadband (UMB), Global System for Mobile communications (GSM) network, GSM/Enhanced Data Rate for GSM Evolution (EDGE) Radio Access Network (GERAN) network, EDGE network, a network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), 5G system or any cellular network or system. Thus, although terminology from LTE may be used in this disclosure to exemplify embodiments herein, this should not be seen as limiting the scope of the embodiments herein to only the aforementioned system. Other wireless systems may also benefit from exploiting the ideas covered within this disclosure. Thus, note that terminology such as eNodeB and UE should be considering non-limiting.

The wireless communications network 100 comprises a plurality of communication devices whereof a first communication device 101, a second communication device 102, and a third communication device 103 are depicted in FIG. 1. The first communication device 101 may be a network node, such as a first network node 111 described below, or a wireless device such as a wireless device 120 described below, which may operate in D2D communication. The second communication device 102 may be a wireless device such as the wireless device 120 described below, or a network node, such as a second network node described below. The third communication device may be a network node, such as a second network node 112 described below. In some particular embodiments, the first communication device 101 may be the same as the second communication device. In the non-limiting particular example illustrated in FIG. 1, the first communication device 101 is the first network node 111, the second communication device 102 is the wireless device 120, and the third communication device 103 is the second network node 112.

The wireless communications network 100 comprises a plurality of network nodes whereof the first network node 111 and the second network node 112 are depicted in FIG. 1. The first network node 111 and the second network node 112 may be a base station such as e.g. an eNB, eNodeB, or a Home Node B, a Home eNodeB, femto Base Station, BS, or any other network unit capable to serve a wireless device or a machine type communication device in the wireless communications network 100. Any of the first network node 111 and the second network node 112 may be e.g. macro eNodeB, or pico base station, based on transmission power and thereby also cell size. In some particular embodiments, any of the first network node 111 and the second network node 112 may be a stationary relay node or a mobile relay node. In the embodiments wherein the wireless communications network 100 is a cellular network, the wireless communications network 100 may cover a geographical area which may be divided into cells, wherein each cell may be served by a network node, although, one network node may serve one or several cells. In the example depicted in FIG. 1, the first network node 111 serves a first cell 131 and the second network node 112 serves a second cell 132. Typically, the wireless communications network 100 may comprise more cells similar to the first cell 131 and the second cell 132, served by their respective network nodes. This is not depicted in FIG. 1 for the sake of simplicity. Any of the first network node 111 and the second network node 112 may support one or several communication technologies, and their name may depend on the technology and terminology used. Any of the first network node 111 and the second network node 112 described above may be implemented in a so-called cloud solution, referring to that the implementation may be distributed, and the any of the first network node 111 and the second network node 112 therefore may be so-called virtual nodes or virtual machines.

In other examples than that depicted in FIG. 1, wherein the wireless communications network 100 is a non-cellular system, e.g., a 5G network, any of the first network node 111 and the second network node 112 may serve receiving nodes such as the second communication device 102, with serving beams.

A number of wireless devices are located in the wireless communications network 100. In the example scenario of FIG. 1, only one wireless device is shown: wireless device 120.

The wireless device 120 is a wireless communication device such as a UE which is also known as e.g. mobile terminal, wireless terminal and/or mobile station, mobile telephone, cellular telephone, or laptop with wireless capability, just to mention some further examples. The wireless device 120 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a surf plate with wireless capability, a Machine-to-Machine (M2M) device, a device equipped with a wireless interface, such as a printer or a file storage device, the modem, or any other radio network unit capable of communicating over a radio link in a wireless communications network 100. The wireless device 120 is wireless, i.e., it is enabled to communicate wirelessly in the wireless communication network 100. The communication may be performed e.g., between two devices, between a device and a regular telephone and/or between a device and a server. The communication may be performed e.g., via a RAN and possibly one or more core networks, comprised within the wireless communications network 100.

The first communication device 101 may communicate with the second communication device 102 over a first link 141, which may be a radio link. The second communication device 102 may communicate with the third communication device 103 over a second link 142, which may be a radio link. The first communication device 101 and the third communication device 103 may communicate with each other with a third link 143, which may be a radio link or a wired link.

In some particular embodiments, any of the the first communication device 101, the second communication device 102, and the third communication device 103 may be each wireless devices such as the wireless device 120, which may communicate via D2D communication.

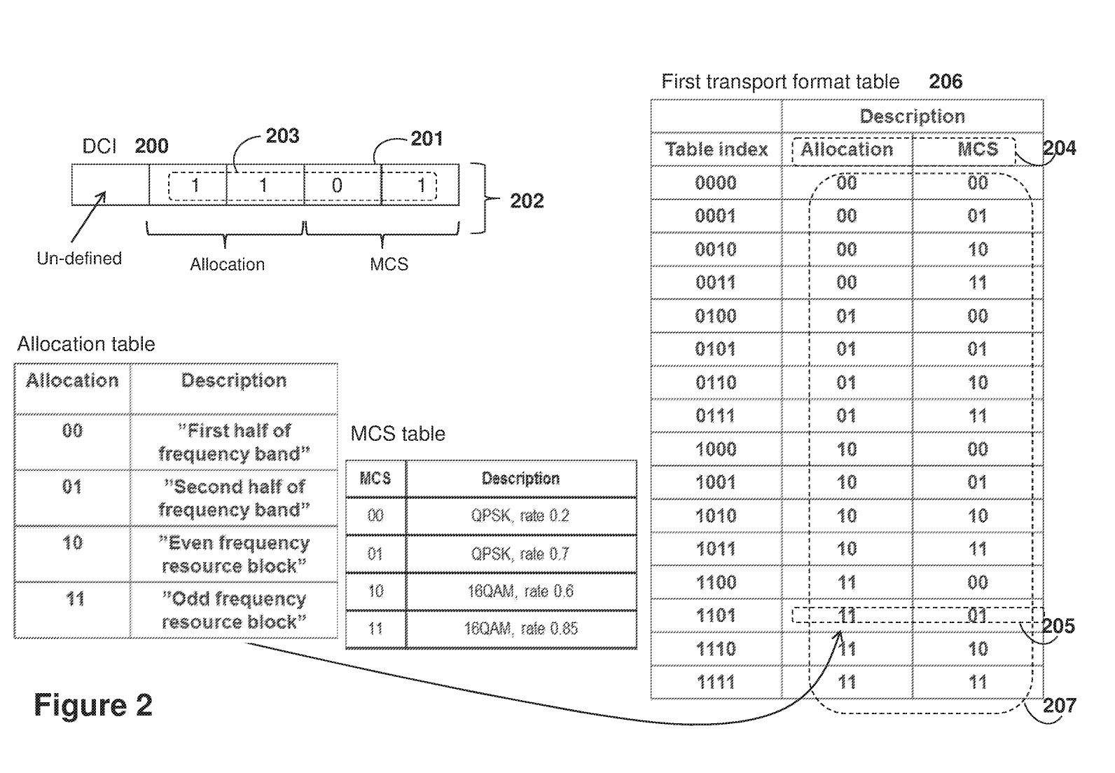

Some aspects of the methods described herein are illustrated in FIG. 2. In the wireless communications network 100, a message 200 is defined as a type of message to communicate control information, as described earlier, to the second communication device 102. The message 200 comprises a sequence of bits 201. A bit may be understood as a unit of information in computing and digital communications. A bit may be unoccupied by any value, or occupied by a value. An occupied bit may have only one of two values, which are most commonly represented as either a 0 or 1. Thus, the message 200 may be understood as a sequence of bits defined, e.g., in a standardized specification, as carrying a particular kind of information, such as control information. Typically, the number of bits in the sequence of bits 201 may be fixed. For example, in some particular embodiments, e.g., wherein the wireless communications network is an LTE network, the type of message 200 is a DCI message format. In such embodiments, the message 200 may comprise a sequence of e.g., 5, 8 or 20 bits, for example.

The bits in the sequence of bits 201 carry information regarding control information variables according to a map, which may establish a correspondence between which bits in the sequence carry information for which control information variables. Control information variables may be understood as variables that define values of control information. Examples of control information variables may be Rank, Allocation, MCS, etc. . . . Examples of values may be e.g., “0”, “01”, “111”, etc. . . .

A first mapping 202 defines how to interpret the message 200 by defining which bits in the sequence of bits 201 comprise a value of a first set of values 203, and for which variable in a first set of control information variables 204. A set may be understood as a group or a plurality. As illustrated in the example of FIG. 2, the first mapping 202 may for example define that a first bit in the sequence of bits 201 remains undefined. That is, the bit is not occupied by any value, as it is not assigned to any control information variable. The first mapping 202 may also define that the second and third bit will carry values for the control information variable “allocation”, whereas the fourth and fifth bits will carry values for the control information variable “MCS”.

In some examples, the first mapping 202 may be to one or more first entries 205 in one or more first tables of control information 206 comprising a first plurality of entries 207 for a plurality of values for the first set of control information variables 204. A table may be understood as a data structure comprised of rows and columns, wherein values for different control information variables are defined across the columns, and wherein the rows define different combination of values for each of the control information variables. In the example of FIG. 2, one of the one or more first entries 205 of the table is comprised by a value “11” for the control information variable Allocation, and a value “01” for the control information variable MCS. These values may in turn be interpreted in reference to a respective Allocation table for Allocation values and a respective MCS table for MCS values, as shown in FIG. 2. As is illustrated in the Figure, the value “11” for the control information variable Allocation corresponds in this example to “Odd frequency resource block” in the Allocation table, whereas the value “01” for the control information variable MCS corresponds to QPSK, rate 0.7 in the MCS table.

In some embodiments, the one or more first tables of control information 206 may be referred to as one or more first transport format tables. The term “transport format table” may apply to the whole process of interpreting decoded control channel information bits in order to obtain the required information for retrieving the data channel information. For example, the first three bits in the sequence of bits 201 may define MCS, the next two bits in the sequence of bits 201 may define number of layers, the next three bits in the sequence of bits 201 define an index to a pre-coding matrix definition table, etc.

A transport format table may be understood as a table with columns defining different transport formats, wherein the control information sent in the message 200 may be an index to a row in the table. In the example of FIG. 2, the message 200 comprises the sequence of values “1101”, which corresponds to a row in the first transport format table with the table index “1101”. In turn, this row corresponds to a value of Allocation “11” and a value of MCS “01”.

A transport format table may also be understood as a set of two or more indices to two or more tables wherein each table may define transmission format information (e.g., MCS). In the example of FIG. 2, the two or more tables are the Allocation table, and the MCS table. The first communication device 101 and the second communication device 102 may have obtained the one or more first tables of control information 206 by e.g., preconfiguration, and may therefore be able to interpret the content of the message 200 according to the first mapping 202.

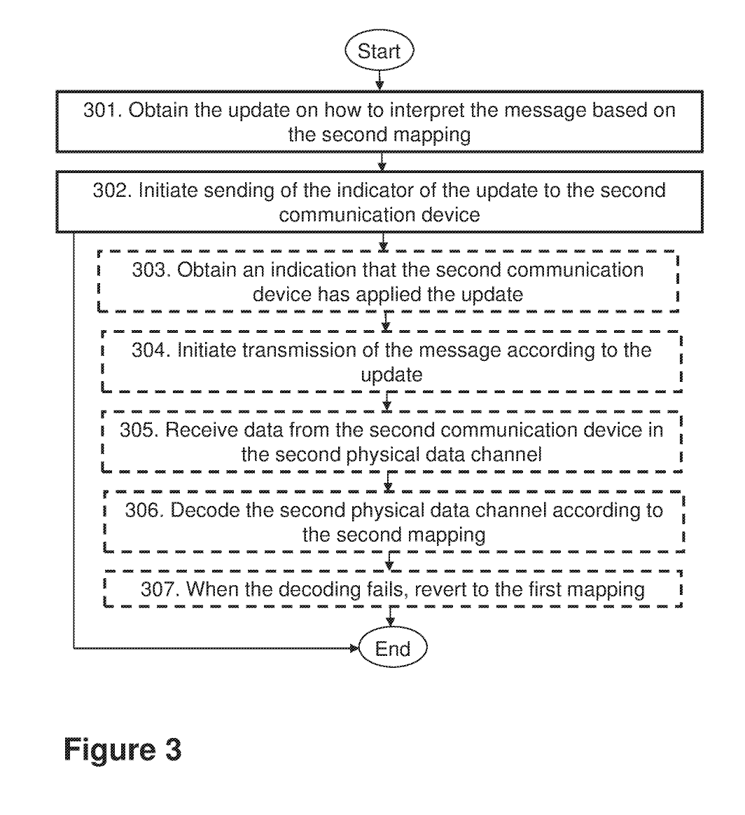

Taking into consideration the context presented in reference to FIG. 2, embodiments of a method performed by the first communication device 101 for facilitating communication of control information to the second communication device 102, will now be described with reference to the flowchart depicted in FIG. 3. As mentioned earlier, the first communication device 101 and the second communication device 102 operate in the wireless communications network 100.

The method may comprise the following actions, which actions may as well be carried out in another suitable order than that described below. In FIG. 3, optional actions are represented as dashed blocks.

Action 301

In the context of the method described herein, the first communication device 101 may initially, e.g. in an initialization phase, communicate the control information to the second communication device 102 with the message 200 according to the first mapping 202. The first communication device 101 may have obtained the first mapping 202 by preconfiguration according to a standard. The first communication device 101 may have also communicated the first mapping 202 to the second communication device 102 by, for example, broadcasting, e.g., in LTE, using System Information (SI).

Based on feedback from the second communication device 102, and/or on the fact that even more data may have arrived in the transmit buffer, a decision may be taken, to update the values of the control information variables used by the second communication device 102 according to the first mapping 202, by changing the interpretation of the bits in the sequence of bits 201 of the message 200. For example, one reason to change the interpretation of the control information bits may be that Channel State Information (CSI) becomes available for the first communication device 101, e.g., by means of receiving feedback from the second communication device 102. Using this CSI, the first communication device 101 may then be able to perform more advanced scheduling assignments, such as frequency selective resource allocations, and/or pre-coder selection. In order to enable this without reconfiguring the configuration of the control information, e.g., downlink control information (DCI), the first communication device 101 may instead re-define the interpretation of the message 200, such that more bits are used e.g. to signal a resource allocation and/or a pre-coder selection.

Another example reason to change the interpretation of the control information bits may be that the first communication device 101 may also need fewer bits to signal some control information variables, such as the rank and/or the modulation order, if the first communication device 101 determines that they will be relative static for a while, and instead signal some other control information variables, e.g., transport block size, using more bits.

Yet another example reason to change the interpretation of the control information bits, may be that the first communication device 101 may typically have little data at the beginning of a TOP transmission burst, and high uncertainty of which operational point the first communication device 101 may want to have, so in the beginning of a burst the first communication device 101 may might want to select rank, modulation, code-rate with a high granularity, and the transport block size with a low granularity. After the TOP slow-start, the first communication device 101 may want to do the opposite.

This decision to change the interpretation of the control information bits may be taken either by the first communication device 101 or by another communication device in the wireless communications network 100, such as the third communication device 103. In the embodiments wherein the first mapping 202 is to the one or more first entries 205 in the one or more first tables of control information 206, the update may refer to an update in the one or more first tables of control information 206 used. The update may refer, for example, to a change affecting which control information variables the message 200 may carry information about, which values of the control information variables the message 200 may carry information about, or which bits in the sequence of bits 201 may define which control information variables.

In order for the first communication device 101 to facilitate a change in the control information that is to be communicated to the second communication device 102, in this action, the first communication device 101 obtains an update on how to interpret the message 200. The first communication device 101 may obtain the update by either receiving it from another communication device, such as the third communication device 103, or by the first communication device 101 calculating or determining the update itself.

In other words, according to this Action 301, instead of obtaining a new format for the message 200, of a certain list of fixed formats, e.g., DCI formats in the case of LTE, the first communication device 101 may obtain a different way to read the content of the same sequence of bits 201 of the message 200. That is, the first communication device 101 may obtain a change or update to the first mapping 202, so that the same sequence of bits 201 in the message 200 may now refer to a different set of values for the same or different control information variables.

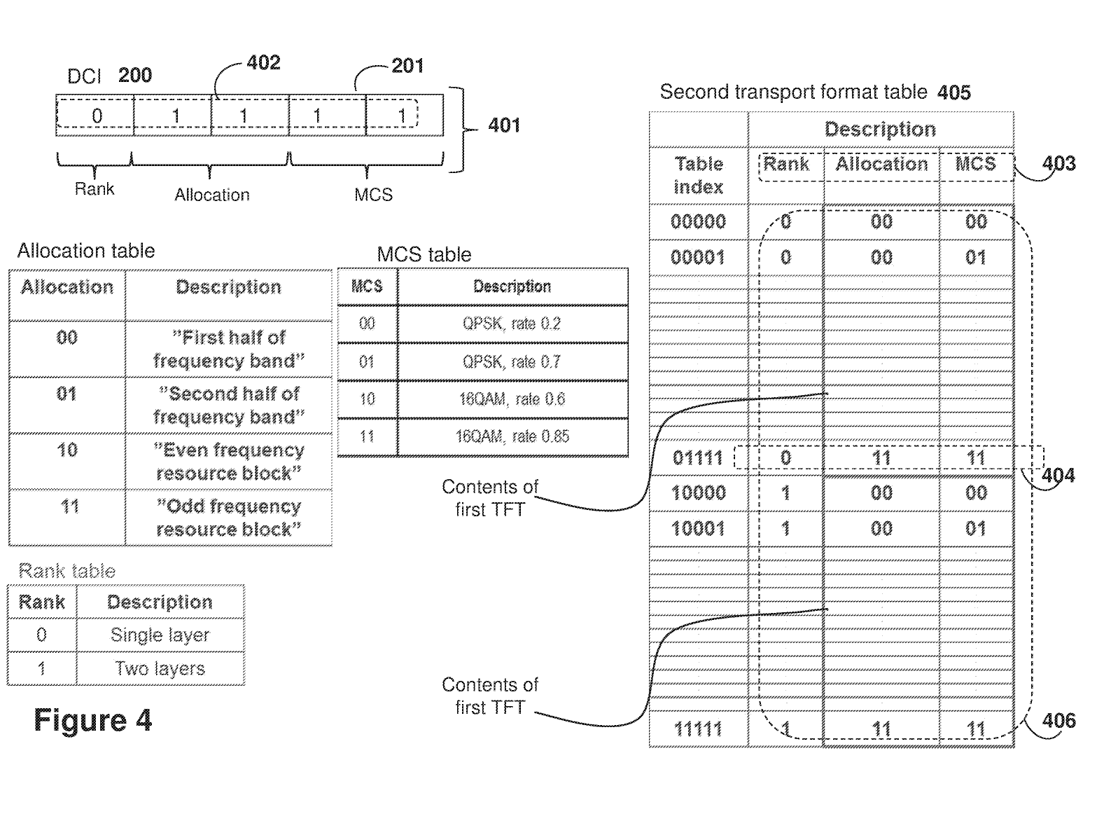

In order to facilitate the description of the update, reference will now be made to FIG. 4, which illustrates an example of the update, based on the sequence of bits 201 of the message 200 that was depicted in the example of FIG. 2. According to Action 301, the update obtained by the first communication device 101 is based on a second mapping 401 to a second set of values 402 for a second set of control information variables 403. The second mapping 401 defines which bits in the sequence of bits 201 comprise a value of the second set of values 402, and for which variable in the second set of control information variables 403. “Second” is used herein as “another”. Another may refer to another time point, for example. Typically, “second” may mean “different”. However, second may not always mean different. In some embodiments for example, the second set of control information variables 403 may be the same as the first set of control information variables 204, but the second set of values 402 may be different than the first set of values 203.

In the example of FIG. 4, the first bit in the sequence of bits 201 of the message 200 now maps, according to the second mapping 401, to a “0” value of the control variable Rank. Also according to the second mapping 401, the second and third bits carry values for the control information variable “allocation”, whereas the fourth and fifth bits carry values for the control information variable “MCS”.

As illustrated in the example of FIG. 4, the second mapping 401 may be to one or more second entries 404 in one or more second tables of control information 405 comprising a second plurality of entries 406 for a plurality of values for the second set of control information variables 403. A second table may be understood as table which is different from the first table, as defined before. In the example of FIG. 4, one entry of the one or more second entries 404 of the second table is comprised by a value “0” for the control information variable “Rank”, a value “11” for the control information variable Allocation, and a value “11” for the control information variable MCS. These values may be interpreted in turn in reference to a respective Rank table for Rank values, a respective Allocation table for Allocation values and a respective MCS table for MCS values, as depicted in the Figure. As is illustrated in FIG. 4, the value “0” for the control information variable Rank corresponds to in this example to “Single layer”, the value “11” for the control information variable Allocation corresponds to “Odd frequency resource block” in the Allocation table, whereas the value “11” for the control information variable MCS corresponds to 16 QAM, rate 0.85 in the MCS table.

In some embodiments, the one or more second tables of control information 405 may be referred to as one or more second transport format tables, as described earlier in regards to the first transport format tables.

The second mapping 401 may also update the correspondence of a same value in the same bits in the message 400 to a different description for the same value, although this is not illustrated in the non-limiting example of FIG. 4. For example, according to the second mapping 401, a value “00” in the bits assigned to the control information variable MCS may correspond to the description of “QPSK rate 0.7”, instead of the original “QPSK rate 0.2”.

In some embodiments, the first mapping 202 and the second mapping 401 may partly overlap. That is, the message 200 may map to identical values of control information variables according to the first mapping 202 and the second mapping 401. According to this, as may be appreciated in FIG. 4, the contents of the second transport table comprise the contents of the first transport format table, for each one of the values of the Rank control information variable.

According to the foregoing, by the fact that the first communication device 101 obtains an update on how to interpret the message 200, defined as a type of message to communicate control information, it may be understood that in the context where the second communication device 102 may use the first mapping 202 to interpret a first set of control messages of the type of message of the message 200, the first communication device 101 obtains an update whereby the second mapping 401 may be used to interpret a second set of control messages of the type of message of the message 200, e.g., at a later time, such as in a different TTI.

To describe some examples of the update, any of the following may be possible: a) at least one of the variables between the second set of control information variables 403 and the variables in the first set of control information variables 204 may be different; b) all the variables in the second set of control information variables 403 may be different from the variables in the first set of control information variables 204; c) a number of variables in the second set of control information variables 403 may be different than a number of variables in the first set of control information variables 204; d) all the variables in the second set of control information variables 403 may be the same as the variables in the first set of control information variables 204; e) all the variables in the second set of control information variables 403 may be the same as the variables in the first set of control information variables 204 and at least a value between the first set of values 203 and the second set of values 402 may be different for a same variable in the first set of control information variables 204 and in the second set of control information variables 403; f) for a certain first set of values 203 according to the first mapping 202, the second set of values 402 the message 200 maps to according to the second mapping 401 may be identical; and g) for at least one of all control information variables, the first mapping 202 may map to different values than the second mapping 401.

The update may comprise at least one of: a control information demux update, a resource allocation determination update, and transmission format interpretation update. A control information demux may be understood as a function that splits a set of control information bits into multiple smaller sets of control information bits, each smaller set communicating a value of one or more parameters, such as control information variables. A resource allocation may be understood as a set of physical resources defined in the time, frequency, and/or code domain used for a data transmission. A transmission format interpretation may be understood as a mapping from a set of control information bits to a transmission format. An example of a transmission format interpretation update according to methods herein may be if for example the sequence of bits 201 in the message 200 has 5 bits of control information, where according to the first mapping 202 the first 2 bits define allocation and next 2 bits define MCS, only QPSK modulation, the update may comprise the following:
(1) Change so that the first 3 bits in the sequence of bits 201define 8 different allocations, and the remaining 2 bits in the sequence of bits 201define MCS;
(2) Change one of the values, say 011, to be associated with a new allocation that may not be described by 3 bits in (1); and
(3) Change, e.g., a value “10”, to define 16 QAM modulation instead of QPSK.

In some examples, the one or more first tables of control information 206 and the one or more second tables of control information 405 is one table, wherein ‘first’ is a first range of entries in the table and while ‘second’ is a second range of entries. In such other examples, the second communication device 102 may initially have knowledge, by specification or configuration, of a short initial table with entries that may be addressed using a small number of bits. This may enable low-overhead transmissions of short potentially time-critical messages to the second communication device 102 over the physical channel, e.g., PDCH₁. In cases with large data transfers, the table may be filled with table entries that may be optimized for specific throughput for the second communication device 102.

Action 302

In order to signal to the second communication device 102 the update, so that the second communication device 102 may interpret the content of the message 200 differently, in this Action, the first communication device 101 initiates sending of an indicator of said update to the second communication device 102. Initiating sending may be understood as triggering the sending of the indicator. For example, in embodiments wherein the first communication device 101 is the first network node 111, e.g., an eNB, the first communication device 101 may itself transmit via the first link 141, e.g., a radio link, the indicator, to the second communication device 102. This may be implemented, for example by sending a message comprising a control information interpretation update to the second communication device 102. The control information interpretation update may be sent e.g., as a MAC control element embedded in a downlink data transmission or as a separate message dedicated to the second communication device 102.

In other embodiments wherein the first communication device 101 may be distributed node, the first communication device 101 may send the indicator to another communication device, which may be in direct communication with the second communication device 102. By doing that, the first communication device 101 may also initiate the sending, by the another communication node, of the indicator, to the second communication device 102.

The indicator may be for example, an index pointing out a pre-defined control information interpretation rule, a bit vector indicating for each element the number of bits used to communicate the value of an associated control information variable, one or more up-dated table entries for a transport format table, etc. . . .

In some examples, the indicator may indicate that a set of entries in the one or more first tables of control information 206 should be jointly altered with respect to one or more parameters. For example, for the control information variable MCS, all values in the range 5-11 should switch from corresponding to 16 QAM to corresponding to 64 QAM.

In some examples, one more entries may be explicitly defined in the indicator, e.g. each entry may be defined completely.

In some examples, a large table containing many entries, for example 1000 entries, may be used for mapping in to the index space of the message 200. For example, if 16 different formats are supported in the message 200, the indicator may indicate that entry 13 should be interpreted as entry 712 in the big table.

In some examples, the entries may be remapped by having multiple tables for different transmission modes, for example, one for MBB and one for Critical MTC. Then the indicator may contain which of the multiple tables should an entry in the table map to.

Combinations of the above examples may also possible.

It should also be noted that the encoding of the indicator may be compressed. That is, fewer bits may be needed to be transmitted, saving radio resources.

The message 200 is devoid of the indicator of the update or an indication of any of the first mapping 202 and the second mapping 401. That is, the indicator is not comprised in the message 200. Accordingly, the content of the message 200 before or after the update may not be differentiated without knowledge about the first mapping 202 or the second mapping 401. In other words, the same values in the sequence of bits 201, e.g., “01101” may mean one thing according to the first mapping 202 and an entirely different thing according to the second mapping 401. It may also be understood from this that the indicator may be provided to the second communication device 102 in a separate message than the message 200. That is, in a separate sequence of bits. The separate message may be referred to herein as an “update message” or a “TFT update message”.

In some embodiments, the sending of the indicator of said update to the second communication device 102 may be on a first physical channel, and the update may apply to the message 200 in a second physical channel. In some embodiments, the first and second physical channels are the same channel, wherein ‘first’ relates to a first Transmission Time Interval (HI), while ‘second’ relates to a second later III, or transport block. In this case the first and second physical channels may refer to data channels such as, respectively, PDCH₁ and PDCH₂ in two instances, where the PDCH₁ may contain the indicator of the update, and PDCH₂ may utilize the indicator.

In some embodiments, the first physical channel may be a non-re-transmittable, direct, physical data channel such as PDCH₁, and the second physical channel may be a re-transmittable physical data channel such as PDCH₂ received by the second communication device 102 in the same TTI. A non-re-transmittable, direct, physical data channel may be understood as a channel wherein data may not be re-transmitted with soft-buffer combining, whereas a re-transmittable physical data channel may be understood as a channel wherein data may be re-transmitted with soft-buffer combining. Soft buffer combining may be understood as the process wherein data which has been retransmitted due to an erroneous decoding of a first transmission of the data, is decoded after combining the retransmission data with data from the first transmission previously stored in a soft buffer. This may be performed to increase the probabilities of a successful decoding of the data in the retransmission. Typically, time-critical information may be mapped to a direct channel, while other data may be mapped to a re-transmittable channel. Control information such as DCI may be typically time-critical, and may therefore be transmitted on a direct physical channel. In some such operational modes the first TFT (Transport Format Table) is used for decoding of PDCH₁ and the second TFT is used for decoding PDCH₂.

The indicator may in some embodiments be carried in a Medium Access Control (MAC) information element, while in other embodiments it may be carried in a Radio Resource Control (RRC) information element.

Action 303

In this action, the first communication device 101 may obtain an indication that the second communication device 102 has applied said update. The indication may be a particular indicator explicitly indicating that the second communication device 102 has applied the update, or it may be another type of message or signal from the second communication device 102, wherefrom the first communication device 101 may derive that the second communication device 102 has applied the update. To have applied the update may be understood as to have used the update, e.g., to decode data, to generate a table, as explained below, etc. . . . For example, the indication may require that an acknowledgement of the update is sent from the second communication device 102. The first communication device 101 may obtain the indication by receiving a feedback message, e.g., an ACK/NACK message, from the second communication device 102. This action is optional.

Action 304

In this action, the first communication device 101 may initiate transmission, to the second communication device 102, of data according to the update. By initiating transmission, it is meant that the first communication device 101 may transmit itself, or trigger another communication device in the wireless communications network 100 to transmit the data. Transmission may be over a physical channel, such as a physical data channel e.g., PDCH₁. This may be performed e.g., via the first link 141.

This action is optional.

Action 305

In this Action, the first communication device 101 may receive data from the second communication device 102 in a second physical data channel, e.g., PDCH₂ via the first link 141.

This action is optional.

Action 306

After receiving the data from the second communication device 102, the first communication device 101 may decode the second physical data channel according to the second mapping 401, e.g., using the one or more second tables of control information 405. Decoding may be understood as reading or interpreting. For example, in LTE decoding is described in 3GPP TS 36.212, V8.8,0, Chapter 5.

This Action may be performed after obtaining the indication that the second communication device 102 has applied the update, according to Action 303.

This action is optional.

Action 307

In some embodiments, when the decoding in Action 306 fails, the first communication device 101 may revert to the first mapping 202 by performing at least one of the following: a) indicating to the second communication device 102 to apply the first mapping 202, e.g., by sending a new indicator; b) decoding the second physical channel according to the first mapping 202; c) using the first mapping 202, e.g., initiate transmission, to the second communication device 102, of data according to the first mapping 202; and d) re-initiating the sending of the indicator of said update to the second communication device 102. By d), it is meant that if the decoding in Action 306 fails, the first communication device 101 may assume that the indicator that was sent as a consequence of Action 302, did not reach the second communication device 202, or it did not reach it correctly. Therefore, the first communication device 101 may decide to try to initiate sending the indicator as in Action 302 once again.

A decoding failure may be understood as a failure in a forward error-correction procedure, meaning that the forward error-correction procedure may not produce a result. For example, in LTE this may happen when one or more Cyclic-Redundancy Checks (CRC) fail on the output of the forward error-correction procedure.

In some embodiments, the first mapping 202 and the second mapping 401 may partly overlap. That is, a subset of the first set of values 203 for the first set of control information variables 204 may be the same as the second set of values 402 for the second set of control information variables 403. In other words, among the collection of control messages that may be sent to second communication device 102, there may be some control messages that may result in same values of control information variables, irrespectively of whether the first mapping 202 or second mapping 401 is used. In this sense the first mapping 202 and second mapping 401 may be understood to partly overlap. Then, when the decoding 306 fails, the message 200 that may be used may map to identical values of control information variables according to the first mapping 202 and the second mapping 401. The advantage of this may be understood as that, if the update fails or it there is uncertainty about whether the update succeeded, the first communication device 101 may use the “common” control messages, which may be correctly interpreted by the second communication device 102, irrespectively of whether the first mapping 202 or second mapping 401 is used.

This action is optional.

To summarize the foregoing in other words, according to the method just described the first communication device 101 may update or create a new table, a.k.a., transport format table, to be utilized for a second physical data channel, wherein the updating/creation may be indicated by the indicator transmitted on the first physical channel. In one example, the first physical channel may be the first physical data channel which may be a non-re-transmittable downlink physical data channel, and the second physical channel may be a second physical data channel which may be a re-transmittable physical data channel. The physical channels may also be the same type of channels wherein the ‘second’ refers to a second transmission time instance. The first and second physical channels may also be a respective downlink and uplink physical data channel.

One benefit of the disclosed method is that the message 200, e.g., a DCI, may be dynamically updated in order to enable optimized operation to the current state of the channel and traffic. Another benefit is that fewer formats for the message 200 to carry control information, such as DCI formats, are required. This simplifies control channel design and dimensioning, because the same number of bits in the sequence of bits 201 may map to much more information according to the second mapping 401. Updating the message 200 also simplifies the blind decoding in the second communication device 102. “Blind decoding” may be understood as referring to when decoding occurs for a number of possibilities. The message 200 may hence be attempted to be decoded in one or more attempts. Only one of the attempts will likely result in correct decoding. In e.g. LTE, each time a new format may be introduced or needed, a new DCI needs to be introduced, and hence the number of DCI may grow over time. With the embodiments disclosed herein, this is not needed.

A further benefit of embodiments herein is that by keeping the decoding of the message 200 intact, as well as other Transmission Mode (TM)-related processes such as feedback, a much faster adaptation is enabled compared to TM selection. Transmission mode may be understood as a mode of transmission, e.g. transmit diversity may only be used, so-called open-loop MIMO scheme may be used, so-called close-loop MIMO scheme may be used, etc. . . . Switching between modes may typically occur by means of RRC re-configuration. Only some selected parts of the interpretation of the message 200 may be dynamically adjusted.

Yet another benefit of embodiments herein is that the bits of the message 200, e.g., DCI bits, may be re-distributed between fields in a dynamic manner.

Furthermore, the embodiments herein invention enable the use of a differential table of control information based a recently used table of control information, resulting in better link-adaptation accuracy and/or lower control channel cost. That is, link adaption may be performed fine-grained, without additional control channel cost.

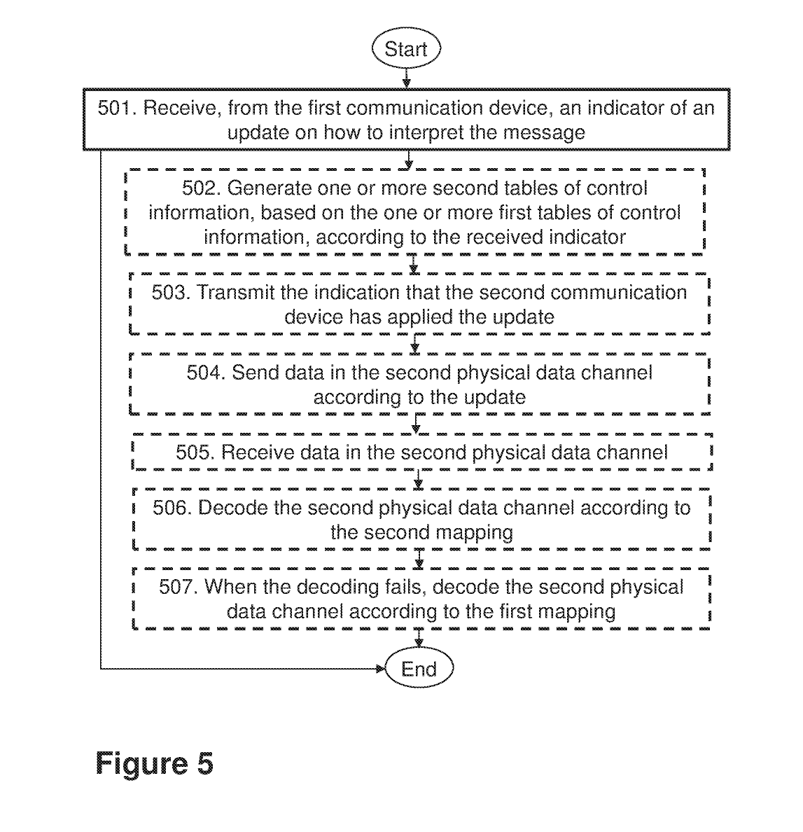

Embodiments of a method performed by the second communication device 102 for facilitating communication of control information from the first communication device 101, will now be described with reference to the flowchart depicted in FIG. 5. As stated earlier, the first communication device 101 and the second communication device 102 operate in the wireless communications network 100.

The detailed description of some of the following corresponds to the same references provided above, in relation to the actions described for the first communication device 101, and will thus not be repeated here. For example, as stated earlier, the message 200 is defined as the type of message to communicate control information to the second communication device 102. The message 200 comprises the sequence of bits 201. The first mapping 202 defines how to interpret the message 200 by defining which bits in the sequence comprise a value of the first set of values 203, and for which variable in the first set of control information variables 204. In some embodiments, the type of message 200 is a DCI message format.

The method may comprise the following actions, which actions may as well be performed in another suitable order than that described below. Optional actions are represented in FIG. 5 with dashed blocks.

Action 501

In this action, the second communication device 102 receives, from the first communication device 101, the indicator of the update on how to interpret the message 200. The update is based on the second mapping 401 to the second set of values 402 for the second set of control information variables 403. The second mapping 401 defines which bits in the sequence comprise a value of the second set of values 402, and for which variable in the second set of control information variables 403.

As stated earlier, the message 200 is devoid of the indicator of the update or an indication of any of the first mapping 202 and the second mapping 401.

In some embodiments, the receiving 301 of the indicator of said update from the first communication device 101 may be on the first physical data channel, e.g., PDCH₁, or on a first physical control channel, e.g., PCCH₁.

As stated earlier, with regards to the update, any of the following may be possible: a) at least one of the variables between the second set of control information variables 403 and the variables in the first set of control information variables 204 may be different; b) all the variables in the second set of control information variables 403 may be different from the variables in the first set of control information variables 204; c) a number of variables in the second set of control information variables 403 may be different than a number of variables in the first set of control information variables 204; d) all the variables in the second set of control information variables 403 may be the same as the variables in the first set of control information variables 204; e) all the variables in the second set of control information variables 403 may be the same as the variables in the first set of control information variables 204 and at least a value between the first set of values 203 and the second set of values 402 may be different for a same variable in the first set of control information variables 204 and in the second set of control information variables 403; f) for a certain first set of values 203 according to the first mapping 202, the second set of values 402 the message 200 maps to according to the second mapping 401 may be identical; and g) for at least one of all control information variables, the first mapping 202 may map to different values than the second mapping 401.

This Action may be implemented by the second communication device 102 receiving, via the first link 141, the indicator carried in a MAC information element, or in an RRC information element.

Action 502

In some embodiments, the first mapping 202 may be to the one or more first entries 205 in the one or more first tables of control information 206 comprising the first plurality of entries 207 for the plurality of values for the first set of control information variables 204. In some of such embodiments, according to this Action 502, the second communication device 102 may generate the one or more second tables of control information 405, based on the one or more first tables of control information 206, according to the received indicator. Generating may be understood as calculating, determining, or constructing. The second mapping 401, in such embodiments, may be to one or more second entries 404 in the generated one or more second tables of control information 405. In such embodiments, the second communication device 102 applying the received update may comprise the second communication device 102 applying the generated one or more second tables of control information 405.

Action 502 is optional.

Action 503

In this action, the second communication device 102 may transmit, e.g. via the first link 141, the indication that said update has been applied. The indication has been described in relation to Action 303.

Action 503 is optional.

Action 504

Some embodiments may relate to the uplink direction. In such embodiments, once the second communication device 102 may have received the indicator of the update, in this action, the second communication device 102 may send data to the first communication device 101 or to the third communication device 103 operating in the wireless communications network 100, in the second physical data channel, according to the update. That is, the second communication device 102 may encode data in the second physical channel, according to control information comprised interpreted from the message 200 according to the update indicated by the received indicator. In some examples, the first physical data channel may be a downlink physical data channel such as PDCH₁ while the second physical channel may be an uplink physical data channel such as PDCH₂.

Action 504 is optional.

Action 505

Some embodiments may relate to the downlink direction. In such embodiments, once the second communication device 102 may have received the indicator of the update, in this action, the second communication device 102 may receive data from the first communication device 101, e.g., via the first link 141, or the third communication device 103 operating in the wireless communications network 100, e.g., via the third second link 142, in the second physical data channel, e.g., PDCH₂.

This Action is optional.

Action 506

Also in some embodiments relating to the downlink direction, the second communication device 102 may decode the second physical data channel according to the second mapping 401. Decoding may be understood as reading or interpreting. For example, in LTE decoding is described in 3GPP TS 36.212, v8.0.0 Chapter 5.

This Action is optional.

Action 507

Similarly to what was described in Action 307 for the first communication device 101, when the decoding the second physical data channel according to the second mapping 401 in Action 506, fails, in this Action 507, the second communication device 102 may decode, the second physical data channel according to the first mapping 202. That is the second communication device 102 may revert to using the first mapping 202. Decoding may be understood as reading or interpreting.

In some embodiments, wherein the first mapping 202 and the second mapping 401 partly overlap, and wherein when the decoding 506 the second physical data channel according to the second mapping 401 fails, the message 200 used maps to identical values of control information variables according to the first mapping 202 and the second mapping 401.

This Action is optional.

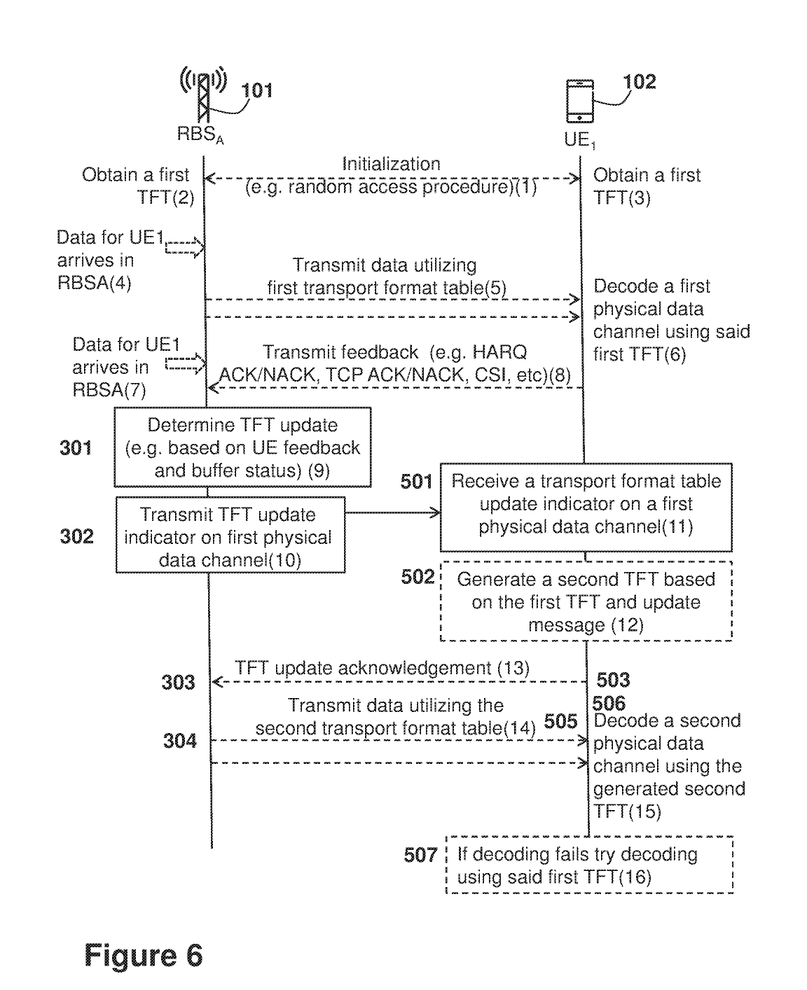

FIG. 6 is a schematic diagram depicting a scenario where a Transmission Format Table is updated according to a particular example in the downlink of embodiments herein. In the non-limiting example of FIG. 6, the first communication device 101 is a Radio Base Station RBS_{A}, and the second communication device 102 is a UE₁. Both are operating in the wireless communications network 100, which in this example is an LTE network. Additional actions to those described in relation to FIGS. 3 and 5 are represented to assist in the understanding of the embodiments herein. During the establishment of a communication between the first communication device 101 and the second communication device 102, both devices go through an initialization procedure, e.g., a random access procedure in (1). A first TFT is then obtained by the first communication device 101 at (2), and by the second communication device 102 at (3), either as defined by a standard and/or as communicated to the second communication device 102 using system information, e.g. in the initialization phase. When data arrives at the first communication device 101 for delivery to the second communication device 102 at (4), the first communication device 101 transmits the data at (5) in the first physical data channel, according to the first TFT. At (6), the second communication device 102 decodes the data received utilizing the first TFT. At (7), more data arrives at the first communication device 10 for delivery to the second communication device 102. At (8), the second communication device 102 transmits feedback, e.g. Hybrid Automatic Retransmission reQuest (HARQ) ACKnowledgement/Negative ACKnowledgement (ACK/NACK), Transmission Control Protocol (TCP) ACK/NACK, Channel State Information (CSI), etc. . . . in the data to the first communication device 101. Based on the transmitted feedback at (8), and/or based on the fact that even more data may have arrived in the transmit buffer at (7), according to Action 301, a decision is taken by the first communication device 101 to update the TFT at (9), and to transmit an indicator for the TFT update in a TFT update message to the second communication device 102 at (10), according to Action 302. At (11), the second communication device 102 receives the indicator, according to Action 501, e.g., in a TFT update message. At (12), according to Action 502, the second communication device 102 generates an updated TFT table. Optionally, at (13) an acknowledgement may be sent from the second communication device 102 to the serving RBS, the first communication device 101 in this example, according to Action 503. The first communication device 101 receives the acknowledgement according to Action 303. After this, at (14), a new transmission of data in the second physical data channel may take place, which utilizes an updated TFT, according to Action 304. The second communication device 102 receives the data according to Action 505, and decodes it using the generated second TFT at (15), according to Action 506. In case of an error event, an optional fallback action is to go back to utilizing the original first TFT at (16), as described in Action 507. Note that optional actions are marked with dashed arrows and boxes.

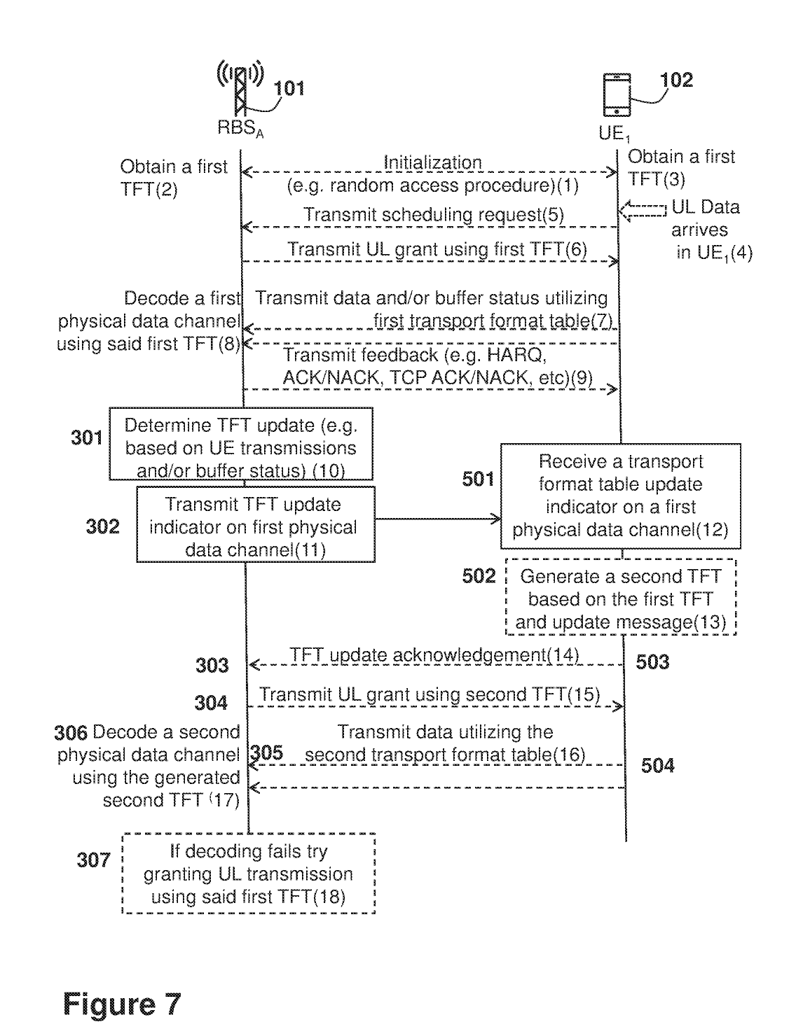

FIG. 7 depicts a similar schematic diagram to that of FIG. 6 with a scenario where a Transmission Format Table is updated according to a particular example in the uplink of embodiments herein. In the non-limiting example of FIG. 7, the first communication device 101 is also a Radio Base Station RBS_{A}, and the second communication device 102 is a UE₁. Both are operating in the wireless communications network 100, which in this example is an LTE network. Additional actions to those described in relation to FIGS. 3 and 5 are represented to assist in the understanding of the embodiments herein. During the establishment of a communication between the first communication device 101 and the second communication device 102, both devices go through an initialization procedure, e.g., a random access procedure in (1). A first TFT is then obtained by the first communication device 101 at (2), and by the second communication device 102 at (3), as described in FIG. 6. When data arrives at the second communication device 102 for transmission at (4), the second communication device 102 transmits a scheduling request to the first communication device 101 at (5). At (6), the first communication device 101 transmits an UL grant utilizing the first TFT. At (7), the second communication device 102 transmits the data and/or a buffer status utilizing the first TFT. The two arrows indicate that multiple transmissions may occur. At (8), the first communication device 101 decodes the first physical data channel using the first TFT. At (9), the first communication device 101 transmits feedback, e.g. Hybrid Automatic Retransmission realest (HARQ) ACKnowledgement/Negative ACKnowledgement (ACK/NACK) in terms of a so-called New Data Indicator (NDI), Transmission Control Protocol (TCP) ACK/NACK, Channel State Information (CSI), etc. . . . in the data to the second communication device 102. Based on the transmitted feedback at (9), and/or based on the buffer status, according to Action 301, a decision is taken by the first communication device 101 to update the TFT at (10), and to transmit an indicator for the TFT update in a TFT update message to the second communication device 102 at (11), according to Action 302. At (12), the second communication device 102 receives the indicator, according to Action 501, on the first physical data channel. At (13), according to Action 502, the second communication device 102 generates an updated TFT table, that is, a second TFT, based on the first TFT and the updated message. Optionally, at (14) an acknowledgement may be sent from the second communication device 102 to the serving RBS, the first communication device 101 in this example, according to Action 503. The first communication device 101 receives the acknowledgement according to Action 303. After this, at (15), a new UL grant may be sent by the first communication device 101 using the second TFT, according to Action 304. At (16), the second communication device 102 transmits the data using the second TTF according to Action 504. The first communication device 101, receives the data at (16) in the second physical data channel according to Action 305, and at (17) decodes the data using the generated second TFT, according to Action 306. In case of an error event, an optional fallback action is to go back to utilizing the original first TFT at (18), as described in Action 307, by granting a new UL transmission using the first TFT. Note that optional actions are marked with dashed arrows and boxes.

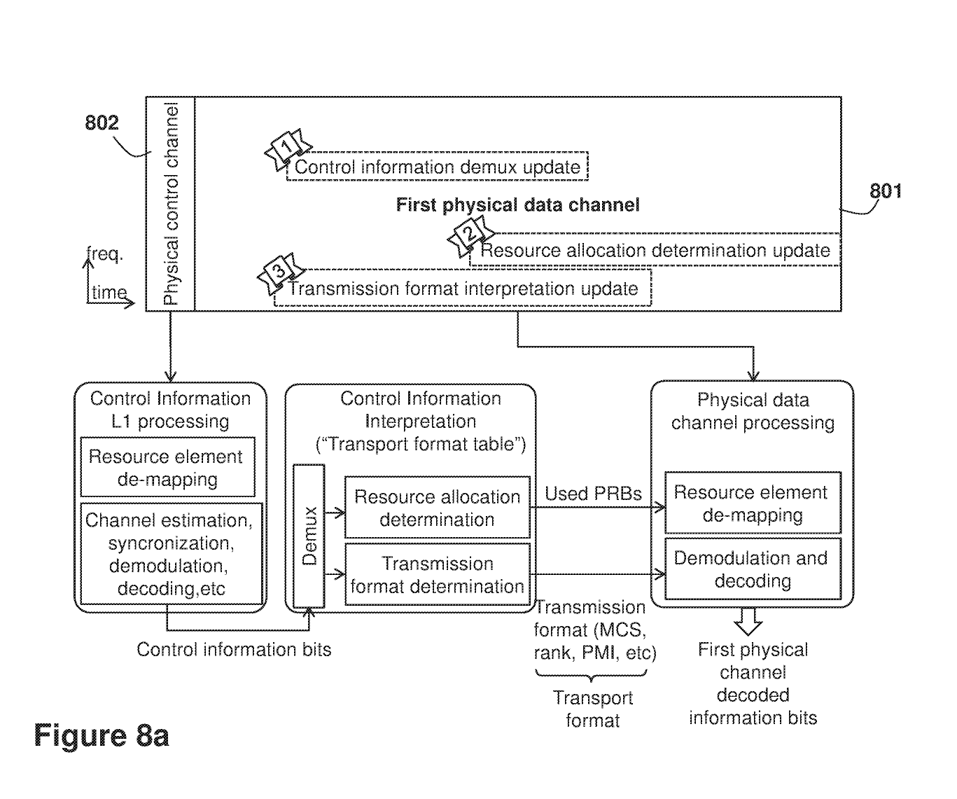

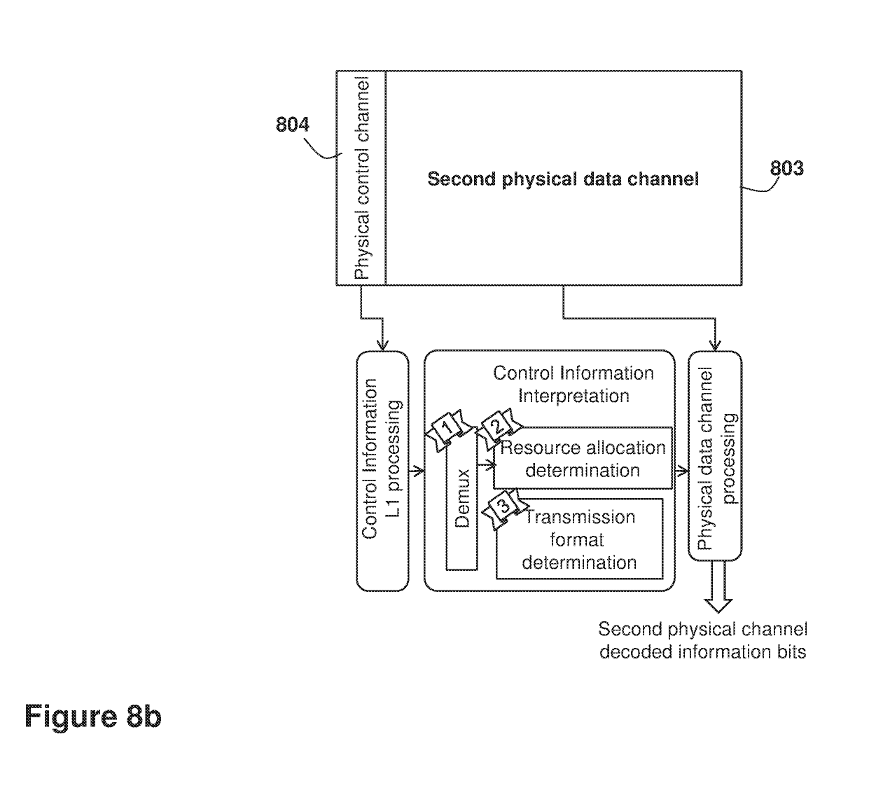

FIG. 8a is a schematic diagram depicting non-limiting different examples of the update, according to embodiments herein, and how the update may be used or applied, in more detail. An update according the embodiments herein may comprise any of the updates 1-3 shown in FIG. 8a, or a combination of any of them, as respective one or more update messages comprised in the indicator. At the top of the FIG. 8a, time-frequency resources corresponding to the first physical data channel 801 and a first physical control channel 802 are represented as a block divided in two parts. This block may correspond to e.g., a first LTE subframe, for example. The first physical data channel 801 may contain the indicator of the update described in Action 302. The update may be a TFT update updating information of different types. A first example (1) of the update is a “control information demux update”, as described earlier, which may change how many of the information bits in the sequence of bits 201 of the message 200 may be used to describe the Physical Resource Block (PRB) allocation of the data carried in a second physical data channel 803, which is depicted in FIG. 8b, and the transmission format of such data. The transmission format may refer to e.g., MCS, rank, Pre-coding Matrix Indicator (PMI), etc. . . . A second example (2) of the update is a message describing a “resource allocation determination update”, as described earlier, comprised in the first physical data channel 801. A third example (3) of the update shows a message for a “transmission format interpretation update”, as described earlier, also comprised in the first physical data channel 801. It may be appreciated that all these are considered to be different kinds of “TFT update messages” that may be comprised in the indicator.

The first physical control channel 802 corresponding to the first LTE frame may, after L1 layer processing, convey information pertaining to resource element de-mapping information, channel estimation, synchronization, demodulation, decoding, etc. . . . This information may be carried in the bits of the sequence of bits 201 of the message 200. The control information carried in the message 200 may be interpreted by mapping the sequence of bits 201 to a table, e.g., a “TFT”. According to the values in the sequence of bits 201 carrying demux information, values for resource allocation and transmission format of data in the first physical data channel 801 may be determined. From the resource allocation determination, used PRBs for the data in the first physical data channel 801 may be determined. From the transmission format determination, the transmission format data in the first physical data channel 801 may be determined. This allows the processing of data in the first physical data channel 801. That is, control information carried in the message 200 allows the resource element de-mapping according to the used PRBs, and the demodulation and decoding of the data according to the determined transmission format. The process of interpreting control information may be described as a table look-up operation, wherein the values of the sequence of bits 201 in the message 200 map to values of certain control information variables in control information table.

FIG. 8b is a continuation of FIG. 8a. At the top of the FIG. 8b, resources corresponding to the second physical data channel 803 and a second physical control channel 804 are represented as a block divided in two parts. This block may correspond to e.g., a second LTE subframe, for example. That is, an LTE subframe at a later time point than the first LTE subframe. FIG. 8b is a schematic diagram depicting how the different examples of the update indicated by the indicator received in the first physical data channel 801 may be used, according to embodiments herein, to interpret the message 200 in the second physical control channel 804. During processing of the control information in the message 200, received in the second physical control channel 804, e.g., during L1 processing, the control information is interpreted or mapped, according to the examples of the update received in the first physical data channel 801. The data contained in the second physical data channel 803 is later processed, e.g., decoded, according to the updated control information. That is, the data may be interpreted according to the received control information demux update, resource allocation determination update, and transmission format interpretation update.

To summarize the foregoing in other words, with some examples, embodiments herein relate to a method for adjustable transport format tables. Embodiments herein may therefore relate to a method for obtaining a second transport format table based on an obtained first transport format table by transmitting the indicator for updating the table.

Hence, the interpretation of a format indication in, for example, a DCI may be dynamically altered. The format indication may for example be MCS, wherein a specific value defining 16 QAM modulation is modified to define e.g. 64 QAM. Another example may be that a default entry 5, wherein of 5 is an index 5 to a table specifying one set of transmission parameters suitable for Mobile BroadBand (MBB) service, after the update that same entry 5 may be interpreted to correspond to a set of transmission parameters suitable for Critical-Machine Type Communication (MTC). Transmission parameters may be understood as e.g., number of layers, pre-coding, modulation and coding.

Embodiments herein enable a fixed small number of DCI formats to be forward compatible and suitable for any mix of services, such as traffic type, e.g. video, machine-type communication, mobile broadband . . . . That is, when new services and new transmission formats may come in the future, there may no longer be a need to define new DCI formats. This is enabled by a configuration of the interpretation of the entries in the DCI. That is, according to embodiments herein, it may be possible to have a few different DCI formats that all communication devices are able to decode, but the contents may be interpreted differently depending how the update indicates they should be interpreted.

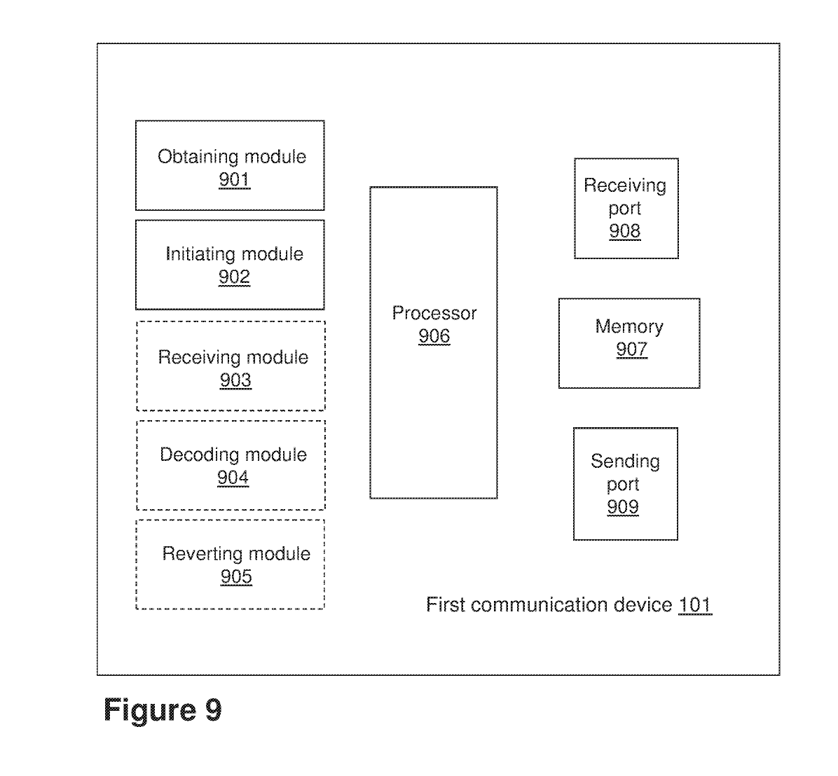

To perform the method actions described above in relation to FIGS. 3 and 6-8, the first communication device 101 is configured to facilitate communication of control information to the second communication device 102. The first communication device 101 comprises the following arrangement depicted in FIG. 9. As already mentioned, the first communication device 101 and the second communication device 102 are configured to operate in the wireless communications network 100.

The detailed description of some of the following corresponds to the same references provided above, in relation to the actions described for the first communication device 101, and will thus not be repeated here. For example, as mentioned earlier, the message 200 is defined as a type of message to communicate control information to the second communication device 102. The message 200 comprises the sequence of bits 201. The first mapping 202 defines how to interpret the message 200 by defining which bits in the sequence of bits 201 comprise a value of the first set of values 203, and for which variable in the first set of control information variables 204.

In some embodiments, the type of message 200 is a DCI message format.

The first communication device 101 is further configured to, e.g., by means of an obtaining module 901 configured to, obtain the update on how to interpret the message 200, the update being based on the second mapping 401 to the second set of values 402 for the second set of control information variables 403, wherein the second mapping 401 defines which bits in the sequence of bits 201 comprise a value of the second set of values 402, and for which variable in the second set of control information variables 403.

The obtaining module 901 may be a processor 906 of the first communication device 101.

In some embodiments, the first communication device 101 may be further configured to, e.g., by means of the obtaining module 901 configured to, obtain the indication that the second communication device 102 has applied said update.

The first communication device 101 is further configured to, e.g., by means of an initiating module 902 configured to, initiate sending of the indicator of said update to the second communication device 102. The message 200 is devoid of the indicator of the update or an indication of any of the first mapping 202 and the second mapping 401.

The initiating module 902 may be the processor 906 of the first communication device 101.

In some embodiments, the first communication device 101 may be further configured to, e.g., by means of the initiating module 902 configured to, initiate transmission, to the second communication device 102, of data according to the update.

In some embodiments, the sending of the indicator of said update to the second communication device 102 is configured to be on the first physical channel, and the update is configured to apply to the message 200 in the second physical channel.

The first communication device 101 may be further configured to, e.g., by means of a receiving module 903 configured to, receive data from the second communication device 102 in the second physical data channel.

The receiving module 903 may be the processor 906 of he first communication device 101.

The first communication device 101 may be further configured to, e.g., by means of a decoding module 904 configured to, decode the second physical data channel according to the second mapping 401.

The decoding module 904 may be the processor 906 of the first communication device 101.

The first communication device 101 may be further configured to, e.g., by means of a reverting module 905 configured to, when the decoding fails, revert to the first mapping 202 by performing at least one of the following: a) indicating to the second communication device 102 to apply the first mapping 202; b) decoding the second physical channel according to the first mapping 202; c) using the first mapping 202; and d) re-initiating the sending of the indicator of said update to the second communication device 102.

The reverting module 905 may be the processor 906 of the first communication device 101.

In some embodiments, the first mapping 202 and the second mapping 401 may partly overlap, and the first communication device 101 may be further configured to, e.g., by means of the reverting module 905 configured to, when the decoding 306 fails, use the message 200 that maps to identical values of control information variables according to the first mapping 202 and the second mapping 401.

In some embodiments, the first mapping 202 may be to the one or more first entries 205 in the one or more first tables of control information 206 comprising the first plurality of entries 207 for the plurality of values for the first set of control information variables 204, and the second mapping 401 may be to the one or more second entries 404 in the one or more second tables of control information 405 comprising the second plurality of entries 406 for the plurality of values for the second set of control information variables 403.

The embodiments herein to facilitate communication of control information to the second communication device 102 may be implemented through one or more processors, such as the processor 906 in the first communication device 101 depicted in FIG. 9, together with computer program code for performing the functions and actions of the embodiments herein. The program code mentioned above may also be provided as a computer program product, for instance in the form of a data carrier carrying computer program code for performing the embodiments herein when being loaded into the in the first communication device 101. One such carrier may be in the form of a CD ROM disc. It is however feasible with other data carriers such as a memory stick. The computer program code may furthermore be provided as pure program code on a server and downloaded to the first communication device 101. The computer program code may also be provided as a service from the cloud. As indicated above, the processor 906 may comprise one or more circuits, which may also be referred to as one or more modules in some embodiments, each configured to perform the actions carried out by the first communication device 101, as described above in reference to FIG. 9, e.g., the obtaining module 901, the initiating module 902, the receiving module 903, the decoding module 904 and the reverting module 905. Hence, in some embodiments, the obtaining module 901, the initiating module 902, the receiving module 903, the decoding module 904 and the reverting module 905 described above may be implemented as one or more applications running on one or more processors such as the processor 906. That is, the methods according to the embodiments described herein for the first communication device 101 may be respectively implemented by means of a computer program product, comprising instructions, i.e., software code portions, which, when executed on at least one processor 906, cause the at least one processor to carry out the actions described herein, as performed by the first communication device 101. The computer program product may be stored on a computer-readable storage medium. The computer-readable storage medium, having stored thereon the computer program, may comprise instructions which, when executed on at least one processor 906, cause the at least one processor to carry out the actions described herein, as performed by the first communication device 101. In some embodiments, the computer-readable storage medium may be a non-transitory computer-readable storage medium, such as a CD ROM disc, a memory stick, or stored in the cloud space. In other embodiments, the computer program product may be stored on a carrier containing the computer program, wherein the carrier is one of an electronic signal, optical signal, radio signal, or the computer-readable storage medium, as described above.

The first communication device 101 may further comprise a memory 907 comprising one or more memory units. The memory 907 may be arranged to be used to store obtained information, such as the information received by the processor 906, store data configurations, scheduling, and applications etc. to perform the methods herein when being executed in the first communication device 101. Memory 907 may be in communication with the processor 906. Any of the other information processed by the processor 906 may also be stored in the memory 907.

In some embodiments, information e.g., from the second communication device 102 or the third communication device 103, may be received through a receiving port 908. The receiving port 908 may be in communication with the processor 906. The receiving port 908 may also be configured to receive other information.

The processor 906 may be further configured to send messages, e.g., to second communication device 102 or the third communication device 103, through a sending port 909, which may be in communication with the processor 906, and the memory 908.

Hence, embodiments herein also relate to the first communication device 101 operative to facilitate communication of control information to the second communication device 102, wherein the message 200 is defined as the type of message to communicate control information to the second communication device 102, wherein the message 200 comprises the sequence of bits 201, and wherein the first mapping 202 defines how to interpret the message 200 by defining which bits in the sequence of bits 201 comprise a value of the first set of values 203, and for which variable in the first set of control information variables 204. The first communication device 101 and the second communication device 102 are operative in the wireless communications network 100. The first communication device 101 comprises the processor 906 and the memory 907. The memory 907 contains instructions executable by said processor 906, whereby said first communication device 101 is operative to: a) obtain the update on how to interpret the message 200, the update being based on the second mapping 401 to the second set of values 402 for the second set of control information variables 403, wherein the second mapping 401 defines which bits in the sequence of bits 201 comprise a value of the second set of values 402, and for which variable in the second set of control information variables 403, and b) initiate sending of the indicator of said update to the second communication device 102. The message 200 is devoid of the indicator of the update or the indication of any of the first mapping 202 and the second mapping 401.

The first communication device 101, may be further operative to initiate transmission, to the second communication device 102, of data according to the update.

The first communication device 101 may be further operative to obtain the indication that the second communication device 102 has applied said update.

The sending of the indicator of said update to the second communication device 102 may be operative to be on the first physical channel, and the update may be operative to apply to the message 200 in the second physical channel.

The first communication device 101 may be further operative to: a) receive data from the second communication device 102 in the second physical data channel, and b) decode the second physical data channel according to the second mapping 401.

In some embodiments, the first communication device 101 may be further operative to, when the decoding fails, revert to the first mapping 202 by performing at least one of the following: a) indicating to the second communication device 102 to apply the first mapping 202; b) decoding the second physical channel according to the first mapping 202; c) using the first mapping 202; and d) re-initiating the sending of the indicator of said update to the second communication device 102.

In some embodiments, the first mapping 202 and the second mapping 401 may partly overlap, and the first communication device 101 may be further operative to, when the decoding 306 fails, use the message 200 that maps to identical values of control information variables according to the first mapping 202 and the second mapping 401.

In some embodiments, the first mapping 202 may be to the one or more first entries 205 in the one or more first tables of control information 206 comprising the first plurality of entries 207 for the plurality of values for the first set of control information variables 204, and the second mapping 401 may be to one or more second entries 404 in the one or more second tables of control information 405 comprising the second plurality of entries 406 for the plurality of values for the second set of control information variables 403.

The type of message 200 may be a DCI message format.

Those skilled in the art will also appreciate that the any module within the first communication device 101, e.g., the obtaining module 901, the initiating module 902, the receiving module 903, the decoding module 904 and the reverting module 905 described above, may refer to a combination of analog and digital circuits, and/or one or more processors configured with software and/or firmware, e.g. stored in the memory, that when executed by the one or more processors such as the processor 906, perform actions as described above, in relation to FIGS. 3 and 6-8. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

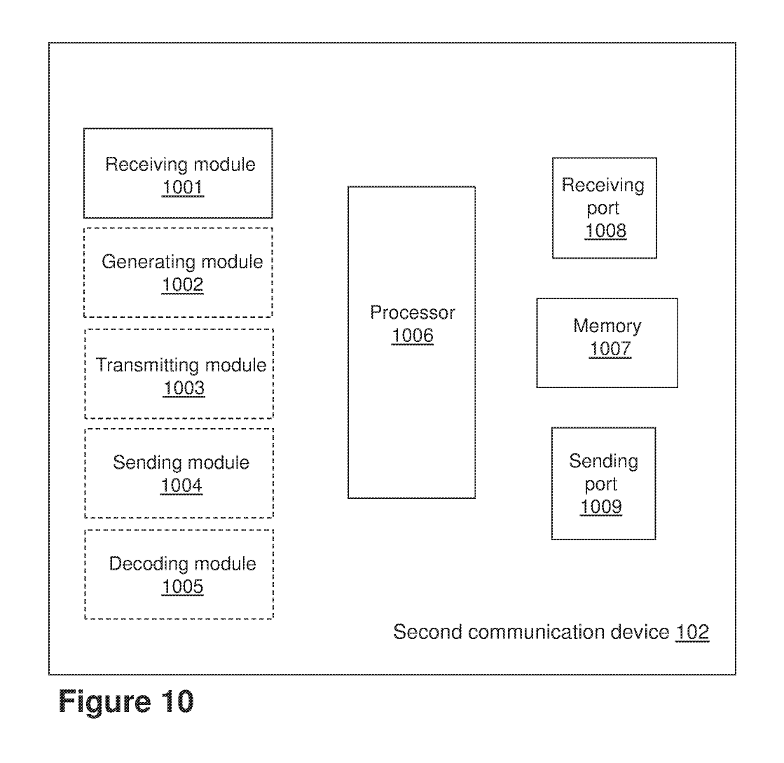

To perform the method actions described above in relation to FIGS. 5, and 6-8, the second communication device 102 is configured to facilitate communication of control information from the first communication device 101. The second communication device 102 comprises the following arrangement depicted in FIG. 10. As already mentioned, the first communication device 101 and the second communication device 102 are configured to operate in the wireless communications network 100.

The detailed description of some of the following corresponds to the same references provided above, in relation to the actions described for the second communication device 102, and will thus not be repeated here. For example, the message 200 is defined as the type of message to communicate control information to the second communication device 102. The message 200 comprises the sequence of bits 201, and the first mapping 202 defines how to interpret the message 200 by defining which bits in the sequence of bits 201 comprise a value of the first set of values 203, and for which variable in the first set of control information variables 204. The type of message 200 may be a DCI message format.

The second communication device 102 is further configured to, e.g., by means of a receiving module 1001 configured to, receive, from the first communication device 101, the indicator of the update on how to interpret the message 200, the update being based on the second mapping 401 to the second set of values 402 for the second set of control information variables 403, wherein the second mapping 401 defines which bits in the sequence of bits 201 comprise the value of the second set of values 402, and for which variable in the second set of control information variables 403. The message 200 is devoid of the indicator of the update or the indication of any of the first mapping 202 and the second mapping 401.

The receiving module 1001 may be a processor 1006 of the second communication device 102.

In some embodiments, the receiving of the indicator of said update from the first communication device 101 is configured to be, e.g., by means of the receiving module 1001 configured to receive the indicator, on the first physical data channel or on the first physical control channel. In such embodiments, the second communication device 102 may be further configured to, e.g., by means of the receiving module 1001 configured to, receive data from the first communication device 101 or the third communication device 103 configured to operate in the wireless communications network 100 in the second physical data channel.

In embodiments, the first mapping 202 is to the one or more first entries 205 in the one or more first tables of control information 206 comprising the first plurality of entries 207 for the plurality of values for the first set of control information variables 204. In such embodiments, the second communication device 102 may be further configured to, e.g., by means of a generating module 1002 configured to, generate the one or more second tables of control information 405, based on the one or more first tables of control information 206, according to the received indicator, and the second mapping 401 may be to the one or more second entries 404 in the generated one or more second tables of control information 405.

The generating module 1002 may be the processor 1006 of the second communication device 102.

The second communication device 102 may be further configured to, e.g., by means of a transmitting module 1003 configured to, transmit the indication that said update has been applied.

The transmitting module 1003 may be the processor 1006 of the second communication device 102.

In some embodiments, the receiving of the indicator of said update from the first communication device 101 may be configured to be on the first physical data channel or on the first physical control channel. In such embodiments, the second communication device 102 may be further configured to, e.g., by means of a sending module 1004 configured to, send data to the first communication device 101 or to the third communication device 103 configured to operate in the wireless communications network 100, in the second physical data channel, according to the update.

The sending module 1004 may be the processor 1006 of the second communication device 102.

The second communication device 102 may be further configured to, e.g., by means of a decoding module 1005 configured to, decode the second physical data channel according to the second mapping 401.

The decoding module 1005 may be the processor 1006 of the second communication device 102.

In some embodiments, the second communication device 102 may be further configured to, when the decoding the second physical data channel according to the second mapping 401 fails, e.g., by means of the decoding module 1005 configured to, decode the second physical data channel according to the first mapping 202.

In some embodiments, the first mapping 202 and the second mapping 401 may partly overlap, and the second communication device 102 may be further configured to, when the decoding 506 the second physical data channel according to the second mapping 401 fails, e.g., by means of the decoding module 1005 configured to, to use the message 200 that maps to identical values of control information variables according to the first mapping 202 and the second mapping 401.

The embodiments herein for the actions performed by the second communication device 102 may be implemented through one or more processors, such as the processor 1006 in the second communication device 102 depicted in FIG. 10, together with computer program code for performing the functions and actions of the embodiments herein. The program code mentioned above may also be provided as a computer program product, for instance in the form of a data carrier carrying computer program code for performing the embodiments herein when being loaded into the in the second communication device 102. One such carrier may be in the form of a CD ROM disc. It is however feasible with other data carriers such as a memory stick. The computer program code may furthermore be provided as pure program code on a server and downloaded to the second communication device 102. The computer program code may also be provided as a service from the cloud. As indicated above, the processor 1006 may comprise one or more circuits, which may also be referred to as one or more modules in some embodiments, each configured to perform the actions carried out by the second communication device 102, as described above in reference to FIG. 10, e.g., the receiving module 1001, the generating module 1002, the transmitting module 1003, the sending module 1004 and the decoding module 1005. Hence, in some embodiments, the receiving module 1001, the generating module 1002, the transmitting module 1003, the sending module 1004 and the decoding module 1005 described above may be implemented as one or more applications running on one or more processors such as the processor 1006. That is, the methods according to the embodiments described herein for the second communication device 102 may be respectively implemented by means of a computer program product, comprising instructions, i.e., software code portions, which, when executed on at least one processor, cause the at least one processor to carry out the actions described herein, as performed by the second communication device 102. The computer program product may be stored on a computer-readable storage medium. The computer-readable storage medium, having stored thereon the computer program, may comprise instructions which, when executed on at least one processor, cause the at least one processor to carry out the actions described herein, as performed by the second communication device 102. In some embodiments, the computer-readable storage medium may be a non-transitory computer-readable storage medium, such as a CD ROM disc, a memory stick, or stored in the cloud space. In other embodiments, the computer program product may be stored on a carrier containing the computer program, wherein the carrier is one of an electronic signal, optical signal, radio signal, or the computer-readable storage medium, as described above.

The second communication device 102 may further comprise a memory 1007 comprising one or more memory units. The memory 1007 may be arranged to be used to store obtained information, such as the information received by the processor 1006, store data configurations, scheduling, and applications etc. to perform the methods herein when being executed in the second communication device 102. Memory 1007 may be in communication with the processor 1006. Any of the other information processed by the processor 1006 may also be stored in the memory 1007.

In some embodiments, information e.g., from the first communication device 101 or the third communication device 103, may be received through a receiving port 1008. The receiving port 1008 may be in communication with the processor 1006. The receiving port 1008 may also be configured to receive other information.

The processor 1006 may be further configured to send messages, e.g., to the first communication device 101 or the third communication device 103, through a sending port 1009, which may be in communication with the processor 1006, and the memory 1007.

Hence, embodiments herein also relate to the second communication device 102 operative to facilitate communication of control information from the first communication device 101. The message 200 is defined as the type of message to communicate control information to the second communication device 102. The message 200 comprises the sequence of bits 201, and the first mapping 202 defines how to interpret the message 200 by defining which bits in the sequence of bits 201 comprise a value of the first set of values 203, and for which variable in the first set of control information variables 204. The first communication device 101 and the second communication device 102 are operative in the wireless communications network 100. The second communication device 102 comprises the processor 1006 and the memory 1007, said memory 1007 containing instructions executable by said processor 1006, whereby said second communication device 102 is operative to: a) receive, from the first communication device 101, the indicator of the update on how to interpret the message 200, the update being based on the second mapping 401 to the second set of values 402 for the second set of control information variables 403, wherein the second mapping 401 defines which bits in the sequence of bits 201 comprise the value of the second set of values 402, and for which variable in the second set of control information variables 403. The message 200 is devoid of the indicator of the update or the indication of any of the first mapping 202 and the second mapping 401.

The first mapping 202 may be to the one or more first entries 205 in the one or more first tables of control information 206 comprising the first plurality of entries 207 for the plurality of values for the first set of control information variables 204, and the second communication device 102 may be further operative to: a) generate the one or more second tables of control information 405, based on the one or more first tables of control information 206, according to the received indicator, and the second mapping 401 may be to the one or more second entries 404 in the generated one or more second tables of control information 405.

The second communication device 102 may be further operative to transmit the indication that said update has been applied.

In some embodiments, the receiving of the indicator of said update from the first communication device 101 may be operative to be on the first physical data channel or on the first physical control channel, and the second communication device 102 may be further operative to send data to the first communication device 101 or to the third communication device 103 operative in the wireless communications network 100, in the second physical data channel, according to the update.

In some embodiments, the receiving of the indicator of said update from the first communication device 101 may be operative to be on the first physical data channel or on the first physical control channel, and the second communication device 102 may be further operative to: a) receive data from the first communication device 101 or the third communication device 103 operative in the wireless communications network 100 in the second physical data channel, and b) decode the second physical data channel according to the second mapping 401.

In some embodiments, the second communication device 102 may be further operative to, when the decoding the second physical data channel according to the second mapping 401 fails, decode the second physical data channel according to the first mapping 202.

In some embodiments, the first mapping 202 and the second mapping 401 may partly overlap, and the second communication device 102 may be further operative to, when the decoding 506 the second physical data channel according to the second mapping 401 fails, to use the message 200 that maps to identical values of control information variables according to the first mapping 202 and the second mapping 401.

The type of message 200 may be a DCI message format.

Those skilled in the art will also appreciate that the any module within the second communication device 102, e.g., the receiving module 1001, the generating module 1002, the transmitting module 1003, the sending module 1004 and the decoding module 1005 described above, may refer to a combination of analog and digital circuits, and/or one or more processors configured with software and/or firmware, e.g. stored in the memory, that when executed by the one or more processors such as the processor 1006, perform actions as described above, in relation to FIGS. 5 and 6-8. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

1-70. (canceled)

71. A method performed by a first communication device for facilitating communication of control information to a second communication device, wherein a message is defined as a type of message to communicate control information to the second communication device, wherein the message comprises a sequence of bits, and wherein a first mapping defines how to interpret the message by defining which bits in the sequence of bits comprise a value of a first set of values, and for which variable in a first set of control information variables, the first communication device and the second communication device operating in a wireless communications network, the method comprising:
obtaining an update on how to interpret the message, the update being based on a second mapping to a second set of values for a second set of control information variables, wherein the second mapping defines which bits in the sequence of bits comprise a value of the second set of values, and for which variable in the second set of control information variables, and
initiating sending of an indicator of said update to the second communication device,
wherein the message is devoid of the indicator of the update or an indication of any of the first mapping and the second mapping.

72. The method of claim 71, further comprising:
initiating transmission, to the second communication device, of data according to the update.

73. The method of claim 71, further comprising:
obtaining an indication that the second communication device has applied said update.

74. The method of claim 71, wherein the sending of the indicator of said update to the second communication device is on a first physical channel, and wherein the update applies to the message in a second physical channel.

75. The method of claim 74, further comprising:
receiving data from the second communication device in a second physical data channel, and
decoding the second physical data channel according to the second mapping.

76. The method of claim 75, wherein when the decoding fails, the method further comprises reverting to the first mapping by performing at least one of the following:
a. indicating to the second communication device to apply the first mapping;
b. decoding the second physical channel according to the first mapping;
c. using the first mapping; and
d. re-initiating the sending of the indicator of said update to the second communication device.

77. The method of claim 76, wherein the first mapping and the second mapping partly overlap, and wherein when the decoding fails, the message used maps to identical values of control information variables according to the first mapping and the second mapping.

78. The method of claim 71, wherein the first mapping is to one or more first entries in one or more first tables of control information comprising a first plurality of entries for a plurality of values for the first set of control information variables, and wherein the second mapping is to one or more second entries in one or more second tables of control information comprising a second plurality of entries for a plurality of values for the second set of control information variables.

79. The method of claim 71, wherein at least one of:
a. at least one of the variables between the second set of control information variables and the variables in the first set of control information variables are different;
b. all the variables in the second set of control information variables are different from the variables in the first set of control information variables;
c. a number of variables in the second set of control information variables is different than a number of variables in the first set of control information variables;
d. all the variables in the second set of control information variables are the same as the variables in the first set of control information variables;
e. all the variables in the second set of control information variables are the same as the variables in the first set of control information variables and at least a value between the first set of values and the second set of values is different for a same variable in the first set of control information variables and in the second set of control information variables;
f. for a certain first set of values according to the first mapping, the second set of values the message maps to according to the second mapping is identical; and
g. for at least one of all control information variables, the first mapping maps to different values than the second mapping

80. A method performed by a second communication device for facilitating communication of control information from a first communication device, wherein a message is defined as a type of message to communicate control information to the second communication device, wherein the message comprises a sequence of bits, and wherein a first mapping defines how to interpret the message by defining which bits in the sequence of bits comprise a value of a first set of values, and for which variable in a first set of control information variables, the first communication device and the second communication device operating in a wireless communications network, the method comprising:
receiving, from the first communication device, an indicator of an update on how to interpret the message, the update being based on a second mapping to a second set of values for a second set of control information variables, wherein the second mapping defines which bits in the sequence of bits comprise a value of the second set of values, and for which variable in the second set of control information variables,
wherein the message is devoid of the indicator of the update or an indication of any of the first mapping and the second mapping.

81. The method of claim 80, wherein the first mapping is to one or more first entries in one or more first tables of control information comprising a first plurality of entries for a plurality of values for the first set of control information variables, and wherein the method further comprises:
generating one or more second tables of control information, based on the one or more first tables of control information, according to the received indicator, and wherein the second mapping is to one or more second entries in the generated one or more second tables of control information.

82. The method of claim 80, wherein the receiving of the indicator of said update from the first communication device is on a first physical data channel or on a first physical control channel, and wherein the method further comprises:
sending data to the first communication device or to a third communication device operating in the wireless communications network, in a second physical data channel, according to the update.

83. The method of claim 80, wherein the receiving of the indicator of said update from the first communication device is on a first physical data channel or a on a first physical control channel, and wherein the method further comprises:
receiving data from the first communication device or a third communication device operating in the wireless communications network in a second physical data channel, and
decoding the second physical data channel according to the second mapping.

84. The method of claim 83, wherein when the decoding the second physical data channel according to the second mapping fails, the method further comprises decoding, the second physical data channel according to the first mapping.

85. The method of claim 84, wherein the first mapping and the second mapping partly overlap, and wherein when the decoding the second physical data channel according to the second mapping fails, the message used maps to identical values of control information variables according to the first mapping and the second mapping.

86. The method of claim 80, wherein the type of message is a Downlink Control Information (DCI) message format.

87. The method of claim 80, wherein one of:
a. at least one of the variables between the second set of control information variables and the variables in the first set of control information variables are different;
b. all the variables in the second set of control information variables are different from the variables in the first set of control information variables;
c. a number of variables in the second set of control information variables is different than a number of variables in the first set of control information variables;
d. all the variables in the second set of control information variables are the same as the variables in the first set of control information variables;
e. all the variables in the second set of control information variables are the same as the variables in the first set of control information variables and at least a value between the first set of values and the second set of values is different for a same variable in the first set of control information variables and in the second set of control information variables;
f. for a certain first set of values according to the first mapping, the second set of values the message maps to according to the second mapping is identical; and
g. for at least one of all control information variables, the first mapping maps to different values than the second mapping.

88. A first communication device operative to facilitate communication of control information to a second communication device, wherein a message is defined as a type of message to communicate control information to the second communication device, wherein the message comprises a sequence of bits, and wherein a first mapping defines how to interpret the message by defining which bits in the sequence of bits comprise a value of a first set of values, and for which variable in a first set of control information variables, the first communication device and the second communication device being operative in a wireless communications network, the first communication device comprising a processor and a memory, said memory containing instructions executable by said processor, whereby said first communication device is configured to:
obtain an update on how to interpret the message, the update being based on a second mapping to a second set of values for a second set of control information variables, wherein the second mapping defines which bits in the sequence of bits comprise a value of the second set of values, and for which variable in the second set of control information variables, and
initiate sending of an indicator of said update to the second communication device,
wherein the message is devoid of the indicator of the update or an indication of any of the first mapping and the second mapping.

89. A second communication device operative to facilitate communication of control information from a first communication device, wherein a message is defined as a type of message to communicate control information to the second communication device, wherein the message comprises a sequence of bits, and wherein a first mapping defines how to interpret the message by defining which bits in the sequence of bits comprise a value of a first set of values, and for which variable in a first set of control information variables, the first communication device and the second communication device being operative in a wireless communications network, the second communication device comprising a processor and a memory, said memory containing instructions executable by said processor, whereby said second communication device is configured to:
receive, from the first communication device, an indicator of an update on how to interpret the message, the update being based on a second mapping to a second set of values for a second set of control information variables, wherein the second mapping defines which bits in the sequence of bits comprise a value of the second set of values, and for which variable in the second set of control information variables,
wherein the message is devoid of the indicator of the update or an indication of any of the first mapping and the second mapping.

90. The second communication device of claim 89, wherein the first mapping is to one or more first entries in one or more first tables of control information comprising a first plurality of entries for a plurality of values for the first set of control information variables, and wherein the second communication device is further configured to:
generate one or more second tables of control information, based on the one or more first tables of control information, according to the received indicator, and wherein the second mapping is to one or more second entries in the generated one or more second tables of control information.
